(19) United States
(12) Patent Application Publication
(10) Pub. No.: US 2025/0358004 A1
(43) Pub. Date: Nov. 20, 2025

(54) COMMUNICATION CONTROL DEVICE, COMMUNICATION CONTROL METHOD, AND PROGRAM

(71) Applicant: SONY GROUP CORPORATION, Tokyo (JP)

(72) Inventor: Kosuke AIO, Tokyo (JP)

(21) Appl. No.: 18/869,408

(22) PCT Filed: May 17, 2023
(86) PCT No.: PCT/JP2023/018381

§ 371 Date: Nov. 26, 2024

(30) Foreign Application Priority Data
Jun. 3, 2022 (JP) 2022-091064

(51) Int. Cl. H04B 7/22; H04B 7/155

(52) U.S. Cl. CPC H04B 7/22; H04B 7/155

(57) ABSTRACT

The present technology relates to a communication control device, a communication control method, and a program that enable appropriate communication of a backscatter signal. The communication control device receives a role request signal requesting execution of a role related to communication of a backscatter signal by a backscatter signal generation device, and determines an operation on the basis of the role request signal. The present technology can be applied to a wireless communication system.

### TECHNICAL FIELD

The present technology relates to a communication control device, a communication control method, and a program, and more particularly to a communication control device, a communication control method, and a program that enable appropriate communication of a backscatter signal.

### BACKGROUND ART

In recent years, in a situation where sensor tags for Internet of Things (IoT) communication are rapidly increasing, Sustainable IoT (Passive IoT) that does not require battery replacement of sensor tags has attracted attention.

There is a plurality of embodiments of the Sustainable IoT, and implementation of a Backscatter Communication System (hereinafter, BCS), which is one of the plurality of embodiments, has been studied. The BCS is a technique in which a sensor tag on a transmission side captures a carrier wave scattered around and reflects and/or absorbs the carrier wave using a method of modulating the carrier wave while controlling reception impedance, thereby transmitting information to a reception side (Reader). According to the BCS, since generation of a carrier wave is not required on the transmission side and an amplifier is not necessary, it is possible to transmit information with small power consumption of several tens of μW.

The BCS has been mainly used in Passive RFIDs so far. In recent years, an Ambient Backscatter Communication System (hereinafter, ABCS) that reflects and/or absorbs various RF signals has been widely studied. In the ABCS, by using an RF signal actually transmitted around instead of a dedicated signal wave, it is not necessary to use a dedicated device for power supply, and it is expected to reduce installation cost. A wireless LAN signal in a 2.4 GHz band is easy to use because a wide band is available and is most widely used among the surrounding RF signals. Therefore, in the ABCS, the wireless LAN signal of the 2.4 GHz band is listed as a candidate for the RF signal to be used.

Non-Patent Document 1 describes an embodiment of an ABCS using a wireless local area network (LAN) protocol. Specifically, Non-Patent Document 1 describes a method of transmitting Backscatter DATA (hereinafter, BCS DATA or backscatter signal) to an Access Point (hereinafter AP) by performing reflection and/or absorption using a method in which a sensor tag (hereinafter, Tag) applies modulation to a data signal to be transmitted from the AP to a station (hereinafter STA).

In this case, since the AP simultaneously performs transmission and reception at the same frequency, it is necessary to support In-band Full Duplex (hereinafter, in-band FD), for example. Hereinafter, a role of transmitting the RF signal to reflect and/or absorb for the Tag to generate the BCS DATA will be called Power Supplier (PS) and a role of receiving the BCS DATA will be called Reader.

Furthermore, Patent Document 1 discloses a radio wave condition training method applicable to the Backscatter Communication System.

### CITATION LIST

### Non Patent Document

Non-Patent Document 1: A. Iqbal and T.-J. Lee, “Communication MAC Protocol for Coexisting Wireless Devices and Backscatter Tags”, [online], 2020 14th International Conference on Ubiquitous Information Management and Communication (IMCOM), 2020, pp. 1-6, doi: 10.1109/IMCOM48794.2020.9001693, [searched on Apr. 6, 2022], Internet <URL: https://ieeexplore.ieee.org/document/9001693>

### Patent Document

Patent Document 1: WO 2021/240699 A

### SUMMARY OF THE INVENTION

### Problems to be Solved by the Invention

Depending on an application, the STA such as a smartphone or a tablet terminal may request information from the Tag. In this case, it is possible to reduce a delay of communication in a case where the STA becomes the Reader and directly receives the BCS DATA from the Tag rather than the case where the AP is in charge of both the Power Supplier and the Reader described in Non-Patent Document 1. Furthermore, when the STA becomes the Power Supplier, it is possible to supply power at necessary timing and to receive information from the Tag with high frequency.

However, an implementable combination of communication devices in charge of the Power Supplier and the Reader depends on Capability information (functions and capabilities) of the AP and the STA. Furthermore, which combination among the combinations of the communication device in charge of the Power Supplier and the communication device in charge of the Reader is optimal also varies depending on dynamically changing factors such as a traffic situation and a positional relationship among the AP, the STA, and the Tag.

Therefore, there is an urgent need for a mechanism for determining which communication devices perform the roles related to the communication of the backscatter signal such as the Power Supplier and the Reader and executing the role.

Note that the training method described in Patent Document 1 is a method of determining beam control that maximizes reception power on the Reader side that receives the BCS DATA, and is not a method of determining the roles such as the Power Supplier and the Reader.

The present technology has been made in view of such a situation, and an object thereof is to enable appropriate communication of a backscatter signal.

### Solutions to Problems

A communication control device according to one aspect of the present technology includes a communication control unit configured to receive a role request signal requesting execution of a role related to communication of a backscatter signal by a backscatter signal generation device, and determine an operation on the basis of the role request signal.

In one aspect of the present technology, a role request signal requesting execution of a role related to communication of a backscatter signal by a backscatter signal generation device is received, and an operation is determined on the basis of the role request signal.

### BRIEF DESCRIPTION OF DRAWINGS

FIG. 1 is a diagram illustrating a configuration example of a wireless communication system according to an embodiment of the present technology.

FIG. 2 is a block diagram illustrating a configuration example of a communication device that operates as an AP.

FIG. 3 is a block diagram illustrating a configuration example of a communication device that operates as an STA.

FIG. 4 is a block diagram illustrating a configuration example of a communication device that operates as a Tag.

FIG. 5 is a diagram illustrating an overall sequence according to the embodiment of the present technology.

FIG. 6 is a diagram illustrating a configuration example of an ABCS Capability Element frame.

FIG. 7 is a diagram illustrating a configuration example of an ABCS Operating Mode Notification frame.

FIG. 8 is a diagram illustrating a first sequence in Training Phase.

FIG. 9 is a diagram illustrating a second sequence in the Training Phase.

FIG. 10 is a diagram illustrating a configuration example of an ABCS TRN Request frame.

FIG. 11 is a diagram illustrating a configuration example of an ABCS TRN Response frame.

FIG. 12 is a diagram illustrating a configuration example of TSP.

FIG. 13 is a diagram illustrating a signal flow among communication devices when a first sequence of ABCS Phase is performed.

FIG. 14 is a diagram illustrating the first sequence of the ABCS Phase.

FIG. 15 is a diagram illustrating a signal flow among communication devices when a second sequence of the ABCS Phase is performed.

FIG. 16 is a diagram illustrating the second sequence of the ABCS Phase.

FIG. 17 is a diagram illustrating a signal flow among communication devices when a third sequence of the ABCS Phase is performed.

FIG. 18 is a diagram illustrating the third sequence of the ABCS Phase.

FIG. 19 is a diagram illustrating a signal flow among communication devices when a fourth sequence of the ABCS Phase is performed.

FIG. 20 is a diagram illustrating the fourth sequence of the ABCS Phase.

FIG. 21 is a diagram illustrating a signal flow among communication devices when a fifth sequence of the ABCS Phase is performed.

FIG. 22 is a diagram illustrating the fifth sequence of the ABCS Phase.

FIG. 23 is a diagram illustrating a signal flow among communication devices when a sixth sequence of ABCS Phase is performed.

FIG. 24 is a diagram illustrating the sixth sequence of the ABCS Phase.

FIG. 25 is a diagram illustrating a signal flow among communication devices when a seventh sequence of the ABCS Phase is performed.

FIG. 26 is a diagram illustrating the seventh sequence of the ABCS Phase.

FIG. 27 is a diagram illustrating a signal flow among communication devices when an eighth sequence of the ABCS Phase is performed.

FIG. 28 is a diagram illustrating the eighth sequence of the ABCS Phase.

FIG. 29 is a diagram illustrating necessary requirements in each sequence.

FIG. 30 is a diagram illustrating a configuration example of an ABCS Request frame.

FIG. 31 is a diagram illustrating a configuration example of an ABCS Response frame.

FIG. 32 is a flowchart for describing processing of the AP when the AP acquires transmission right.

FIG. 33 is a flowchart for describing processing of the STA when the AP acquires transmission right.

FIG. 34 is a flowchart for describing processing of the STA when the STA acquires transmission right.

FIG. 35 is a flowchart for describing processing of the AP when the STA acquires transmission right.

FIG. 36 is a block diagram illustrating another configuration example of a communication device that operates as an AP.

FIG. 37 is a block diagram illustrating another configuration example of a communication device that operates as an STA.

FIG. 38 is a diagram illustrating another configuration example of a wireless communication system according to an embodiment of the present technology.

FIG. 39 is a block diagram illustrating a configuration example of a computer.

FIG. 40 is a block diagram illustrating a schematic configuration example of a smartphone to which the present technology is applied.

FIG. 41 is a block diagram illustrating a schematic configuration example of an in-vehicle device to which the present technology is applied.

FIG. 42 is a block diagram illustrating a schematic configuration example of a wireless AP to which the present technology is applied.

### MODE FOR CARRYING OUT THE INVENTION

Hereinafter, modes for carrying out the present technology will be described. The description will be given in the following order.
1. Embodiments
2. Modifications
3. Application Example
4. Others

### 1. Embodiment

### <System Configuration>

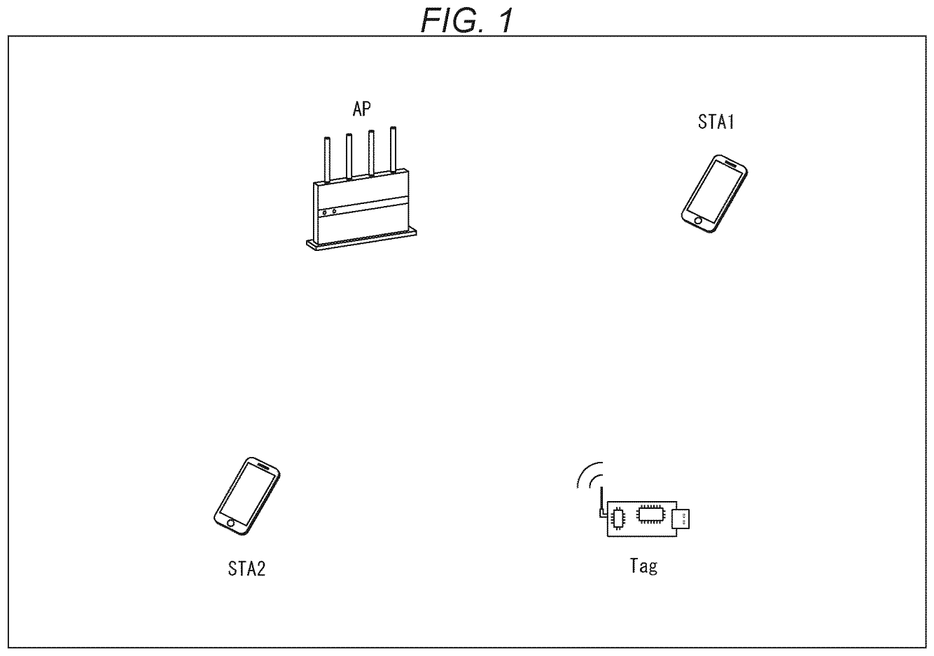

FIG. 1 is a diagram illustrating a configuration example of a wireless communication system according to an embodiment of the present technology.

The wireless communication system of FIG. 1 is a system that performs ABCS communication for receiving BCS DATA to which information such as sensor data from a Tag is added, using a surrounding scattered wave instead of a dedicated signal wave.

In FIG. 1, the wireless communication system includes one AP, an STA1 and an STA2 that are two STAs, and one sensor tag, Tag. Note that the STA1 and the STA2 will be referred to as STA(s) in a case where it is not particularly necessary to distinguish them.

The AP transmits a signal to the STA1.

The STA1 and the STA2 are connected to the AP. The STA1 receives a signal transmitted from the AP. The STA2 directly receives (acquires) the BCS DATA transmitted from the Tag. Note that there is a case where the AP once receives the BCS DATA transmitted from the Tag and then transmits (transfers) the BCS DATA to the STA2, whereby the STA2 indirectly receives the BCS DATA, depending on Capability information and a communication quality status to be described below.

The Tag transmits the BCS DATA (backscatter signal), which is a wireless signal, to the STA2, using a method of modulating, reflecting and/or absorbing a wireless signal transmitted from a surrounding AP or STA.

Note that the target system configuration in the present technology is not limited thereto. That is, in the target system configuration, it is sufficient if a plurality of communication devices to which connection is established exists, and other communication devices exist around each of the communication devices. Furthermore, any positional relationship between the communication devices is acceptable as long as the above-described communication in FIG. 1 is performed.

For example, an AP may function as an STA in the wireless communication system of FIG. 1, and the wireless communication system may be configured as a system that performs ABCS communication using ad-hoc communication (P2P communication) between STAs.

### <Configuration of Communication Device>

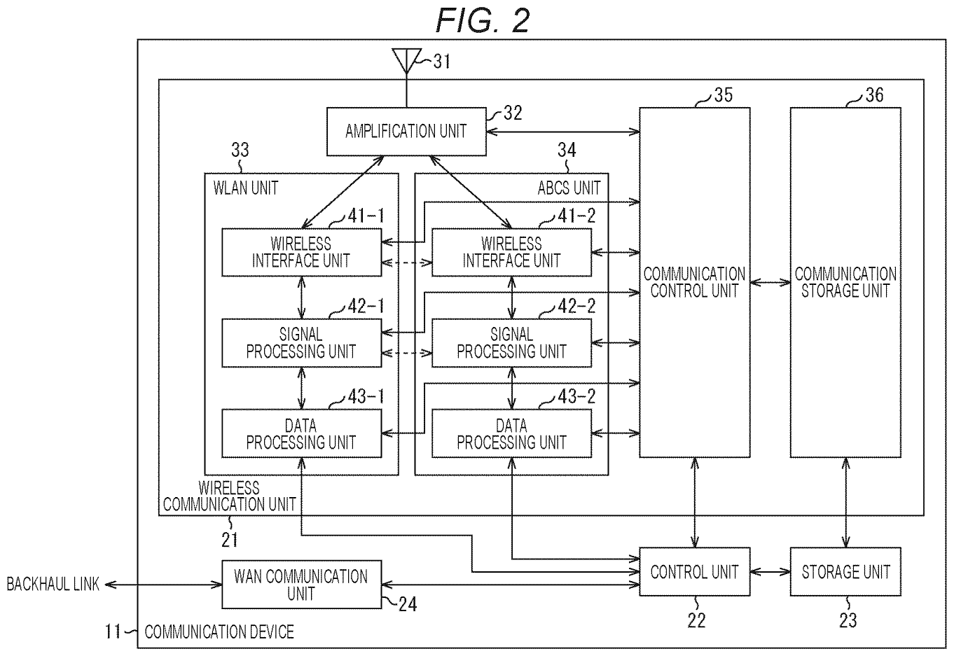

FIG. 2 is a block diagram illustrating a configuration example of a communication device that operates as the AP.

A communication device 11 includes a wireless communication unit 21, a control unit 22, a storage unit 23, and a wide area network (WAN) communication unit 24.

The wireless communication unit 21 transmits and receives data.

The wireless communication unit 21 includes an antenna 31, an amplification unit 32, a WLAN unit 33 that is a block for wireless LAN communication, an ABCS unit 34 that is a block for ABCS communication, a communication control unit 35, and a communication storage unit 36. That is, in the wireless communication unit 21, the antenna 31 and the amplification unit 32 are shared by the WLAN unit 33 and the ABCS unit 34.

The WLAN unit 33 includes a wireless interface unit 41-1, a signal processing unit 42-1, and a data processing unit 43-1. The ABCS unit 34 includes a wireless interface unit 41-2, a signal processing unit 42-2, and a data processing unit 43-2.

Note that, in a case where it is not necessary to distinguish the wireless interface units 41-1 and 41-2, they are referred to as wireless interface unit(s) 41. In a case where it is not necessary to distinguish the signal processing units 42-1 and 42-2, they are referred to as signal processing unit(s) 42. In a case where it is not necessary to distinguish the data processing units 43-1 and 43-2, they are referred to as data processing unit(s) 43.

Hereinafter, processing content in each block will be described assuming a wireless LAN, but the ABCS unit 34 does not need to support the entire processing content and may perform only some part of the processing content. Furthermore, the ABCS unit 34 may perform a unique operation according to a wireless standard used for transmission of the BCS DATA.

Note that the AP may include a larger number of the antennas 31 and the amplification units 32 to enable high-dimensional multi-input multi-output (MIMO) transmission/reception processing. Furthermore, the AP may include a plurality of the wireless interface units 41, a plurality of the signal processing units 42, and a plurality of the data processing units 43 so as to operate a plurality of links or a plurality of frequency channels in parallel.

At the time of transmission, the amplification unit 32 amplifies power of an analog signal supplied from the wireless interface unit 41 to predetermined power, and outputs the analog signal with the amplified power to the antenna 31. At the time of reception, the amplification unit 32 amplifies power of an analog signal supplied from the antenna 31 to predetermined power, and outputs the analog signal with the amplified power to the wireless interface unit 41.

A part of the function of the amplification unit 32 may be included in the wireless interface unit 41. Furthermore, a part of the function of the amplification unit 32 may be a component outside the wireless communication unit 21.

At the time of transmission, the wireless interface unit 41 converts a transmission symbol stream from the signal processing unit 42 into an analog signal, and performs filtering, up-conversion to a carrier frequency, and phase control. The wireless interface unit 41 outputs the analog signal after the phase control to the amplification unit 32.

At the time of reception, the wireless interface unit 41 performs phase control, down-conversion, and reverse filtering for the analog signal supplied from the amplification unit 32, and outputs a reception symbol stream obtained as a result of conversion into a digital signal to the signal processing unit 42.

Here, as indicated by the dashed arrows in FIG. 2, the wireless interface units 41 and the signal processing units 42 of the WLAN unit 33 and the ABCS unit 34 may be designed to exchange information with each other. In this case, the connection between the wireless interface units 41 is used for information exchange for causing an analog interference canceller to function. Furthermore, the connection between the signal processing units 42 is used for information exchange for causing a digital interference canceller to function. In a case where In-band FD or Non-orthogonal Multiple Access (NOMA) is performed in the communication device 11, at least one interference canceller is used.

At the time of transmission, the signal processing unit 42 performs encoding, interleaving, modulation, and the like for a data unit supplied from the data processing unit 43, adds a physical header, and generates a transmission symbol stream. The signal processing unit 42 outputs the generated transmission symbol stream to each wireless interface unit 41.

At the time of reception, the signal processing unit 42 analyzes the physical header of the reception symbol stream supplied from each wireless interface unit 41, performs demodulation, deinterleaving, decoding, and the like for the reception symbol stream, and generates a data unit. The signal processing unit 42 outputs the generated data unit to the data processing unit 43.

Note that the signal processing unit 42 performs complex channel characteristic estimation processing and spatial separation processing as necessary.

Furthermore, the signal processing unit 42 of the ABCS unit 34 generates a symbol stream of Tag Selection Pulse (hereinafter, TSP), which is a signal that permits the Tag to transmit the BCS DATA.

At the time of transmission, the data processing unit 43 performs sequence management and encryption processing of data held in the communication storage unit 36 and a control signal and management information received from the communication control unit 35. After the encryption processing, the data processing unit 43 adds a media access control (MAC) header and an error detection code to generate a packet. The data processing unit 43 performs concatenation processing of a plurality of the generated packets.

At the time of reception, the data processing unit 43 performs decoupling processing of the received packet, analysis of the MAC header, error detection, retransmission request operation, and reorder processing.

The communication control unit 35 controls operation of each unit of the wireless communication unit 21 and information transmission between the units. Furthermore, the communication control unit 35 performs control to transfer the control signal and the management information to be notified to another communication device to the data processing unit 43.

The communication storage unit 36 holds information to be used by the communication control unit 35. Furthermore, the communication storage unit 36 holds packets to be transmitted and received packets. A transmission buffer that holds the packets to be transmitted is included in the communication storage unit 36.

There may be a plurality of the wireless communication units 21. For example, the communication between the APs and the communication between the AP and the STA may be performed using different wireless communication units 21.

The control unit 22 includes a central processing unit (CPU), a read only memory (ROM), and a random access memory (RAN). The control unit 22 executes a program stored in the ROM or the like, and controls the wireless communication unit 21 and the communication control unit 35. Furthermore, the control unit 22 may also perform a part of the operation of the communication control unit 35 instead. Furthermore, the communication control unit 35 and the control unit 22 may be configured as one block.

The storage unit 23 holds information to be used by the wireless communication unit 21 and the control unit 22. Furthermore, the storage unit 23 may also perform a part of the operation of the communication storage unit 36 instead. The storage unit 23 and the communication storage unit 36 may be configured as one block.

The WAN communication unit 24 analyzes the packet acquired from a backhaul link that is a communication path with the AP, and passes the analyzed packet to the wireless communication unit 21 via the control unit 22. The format of the transferred packet may be a state in which an IP Header is left as it is (access point mode) or a state in which the IP Header is removed by the WAN communication unit 24 (router mode).

Note that FIG. 2 illustrates an example in which the wireless communication unit 21 is configured as one IC, but the IC configuration of the present technology is not limited thereto. For example, the wireless interface unit 41 may be mounted as an IC different from the IC of the wireless communication unit 21.

### <Configuration of Communication Device>

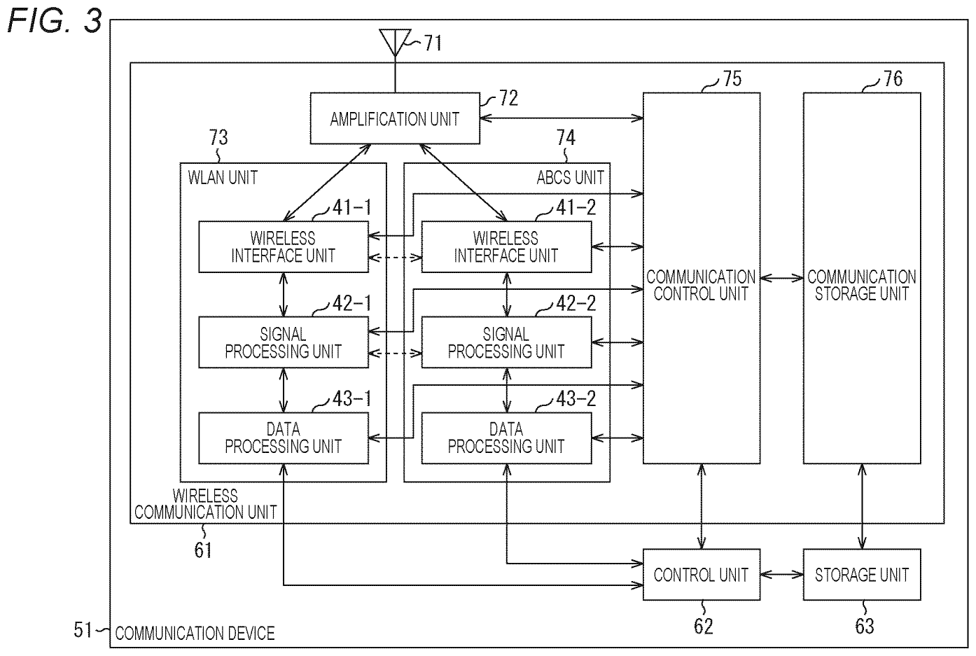

FIG. 3 is a block diagram illustrating a configuration example of a communication device that operates as the STA.

A communication device 51 includes a wireless communication unit 61, a control unit 62, and a storage unit 63.

The configurations of the control unit 62 and the storage unit 63 in FIG. 3 are similar to the configurations of the control unit 22 and the storage unit 23 in FIG. 2.

The wireless communication unit 61 includes an antenna 71, an amplification unit 72, a WLAN unit 73, an ABCS unit 74, a communication control unit 75, and a communication storage unit 76.

The configurations of the antenna 71, the amplification unit 72, the WLAN unit 73, the ABCS unit 74, the communication control unit 75, and the communication storage unit 76 in FIG. 3 are similar to the configurations of the antenna 31, the amplification unit 32, the WLAN unit 33, the ABCS unit 34, the communication control unit 35, and the communication storage unit 36 in FIG. 2.

### <Configuration of Communication Device>

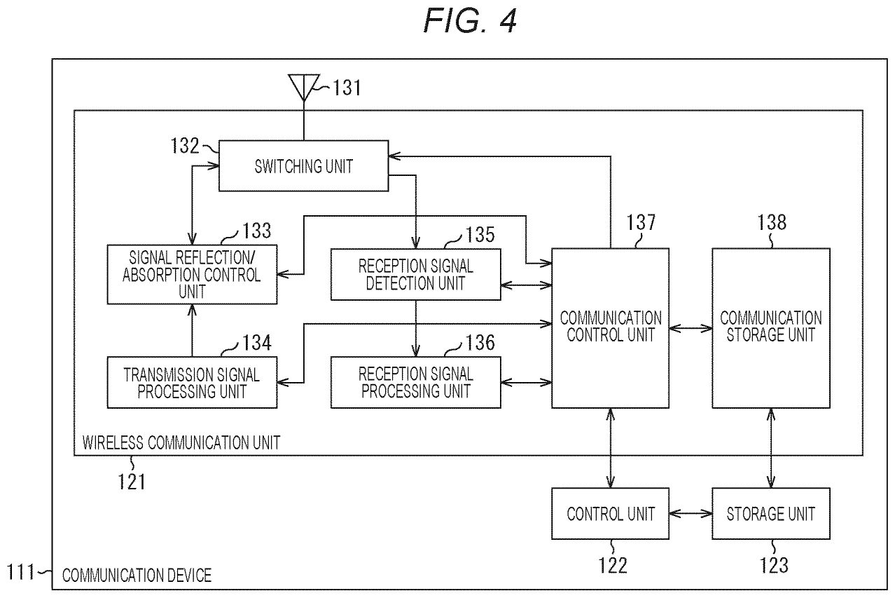

FIG. 4 is a block diagram illustrating a configuration example of a communication device that operates as the Tag.

A communication device 111 includes a wireless communication unit 121, a control unit 122, and a storage unit 123.

The configurations of the control unit 122 and the storage unit 123 in FIG. 4 are similar to the configurations of the control unit 22 and the storage unit 23 in FIG. 2.

The wireless communication unit 121 includes an antenna 131, a switching unit 132, a signal reflection/absorption control unit 133, a transmission signal processing unit 134, a reception signal detection unit 135, a reception signal processing unit 136, a communication control unit 137, and a communication storage unit 138. Note that the communication device 111 is different from the communication device 11 of FIG. 2 and the communication device 51 of FIG. 3 in that no amplification unit is present.

The switching unit 132 switches an input destination of a received wave received by the antenna 131. Specifically, after operating the reception signal detection unit 135 and acquiring a signal including its own identification information, the switching unit 132 switches the operation to the signal reflection/absorption control unit 133 to perform control to transmit the BCS DATA.

The signal reflection/absorption control unit 133 controls impedance of a reception circuit that reflects and/or absorbs an RF wave acquired from the antenna 131, and generates a transmission signal to which information of the symbol stream generated by the transmission signal processing unit 134 is added.

The transmission signal processing unit 134 performs encoding, interleaving, modulation, and the like for the data held in the communication storage unit 138 and control information and the management information received from the communication control unit 137. Then, the transmission signal processing unit 134 adds the physical header to the modulated data and information to generate the symbol stream. The transmission signal processing unit 134 outputs the generated symbol stream to the signal reflection/absorption control unit 133.

The reception signal detection unit 135 detects the TSP from the signal acquired by the switching unit 132, performs down-conversion, filtering, and analog-to-digital signal conversion to generate the symbol stream.

The reception signal processing unit 136 decodes the symbol stream generated by the reception signal detection unit 135 and acquires information.

The communication control unit 137 controls operation of each unit constituting the wireless communication unit 121 and information transmission between the units. Furthermore, the communication control unit 137 performs control to transfer the control information and the management information to be notified to another communication device to the reception signal processing unit 136.

The communication storage unit 138 holds information to be used by the communication control unit 137. Furthermore, the communication storage unit 138 holds a data packet to be transmitted and a received data packet. The communication storage unit 138 includes a transmission buffer that holds the data packets to be transmitted.

### <Overall Sequence>

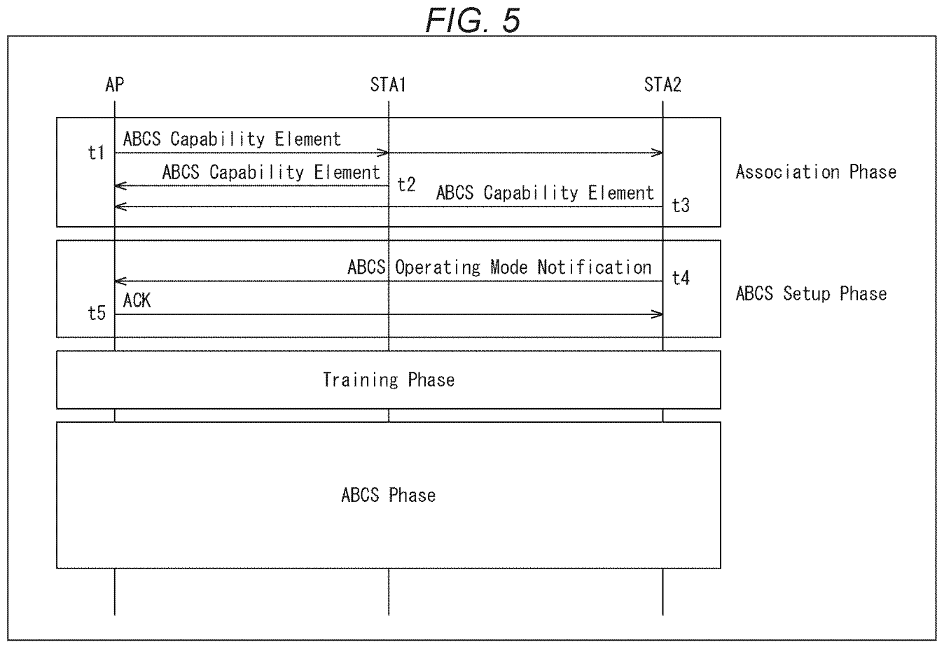

FIG. 5 is a diagram illustrating an overall sequence according to an embodiment of the present technology.

In FIG. 5, the overall sequence includes an Association Phase, an ABCS Setup Phase, a Training Phase, and an ABCS Phase. Note that, in FIG. 5, the processing by the AP, STA1, and STA2 will be mainly described, and thus the Tag is omitted for convenience of description.

In the Association Phase, the AP, and the STA1 and the STA2 perform connection processing and authentication processing between the APs and the STA. At that time, an ABCS Capability Element is included in any of frames for which the connection processing or the authentication processing is performed.

For example, at timing t1, the AP transmits the frame including the ABCS Capability Element to the STA1 and the STA2. The STA1 and the STA2 receive the frame transmitted from the AP.

At timing t2, the STA1 transmits the frame including the ABCS Capability Element to the AP. The AP receives the frame transmitted from the STA1.

At timing t3, the STA2 transmits the frame including the ABCS Capability Element to the AP. The AP receives the frame transmitted from the STA2.

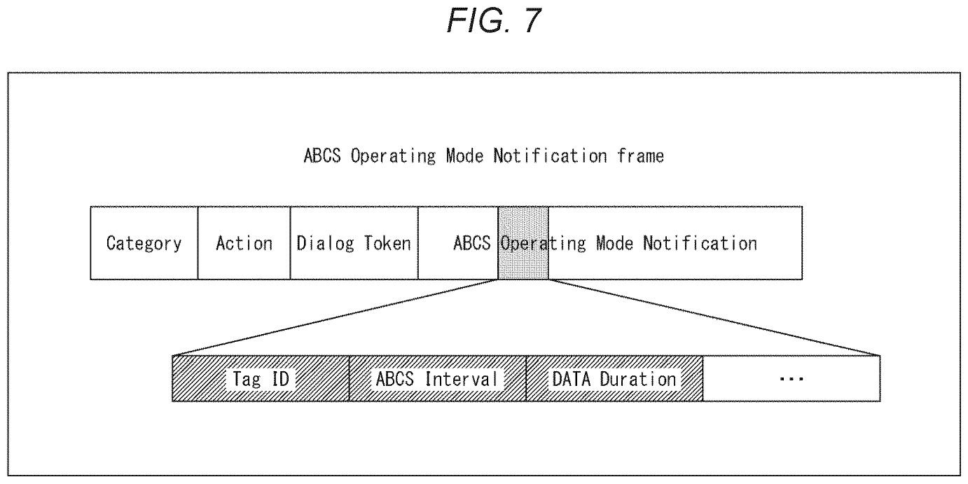

Note that the frame including the ABCS Capability Element transmitted at the timing t1 to t3 is one of the frames for which the connection processing or the authentication processing is performed (for example, frames of Beacon, Probe Request, Probe Response, Association Request, Association Response, and the like). Details of the ABCS Capability Element frame will be described below with reference to FIG. 7.

In the ABCS Setup Phase, the AP performs initial setting for collecting information from the Tag in response to a request transmitted from the STA2.

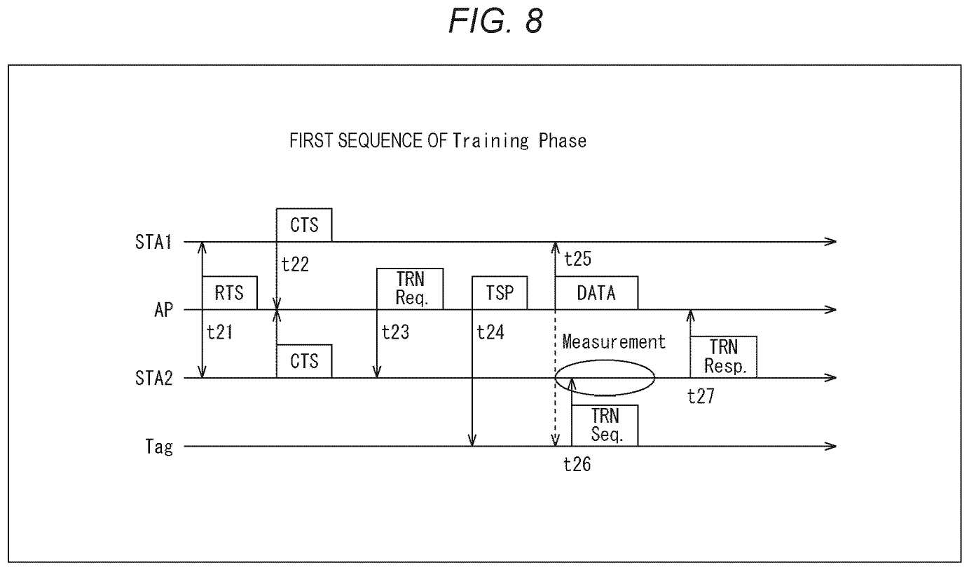

For example, at timing t4, the STA2 transmits an ABCS Operation Mode Notification frame, which is a request signal for receiving information from the Tag (that is, for performing communication of ABCS), to the AP. Details of the ABCS Operation Mode Notification frame will be described below with reference to FIG. 8.

The AP receives the ABCS Operation Mode Notification frame, and transmits an ACK frame, which is a reception confirmation response signal, to the STA2 at timing t5.

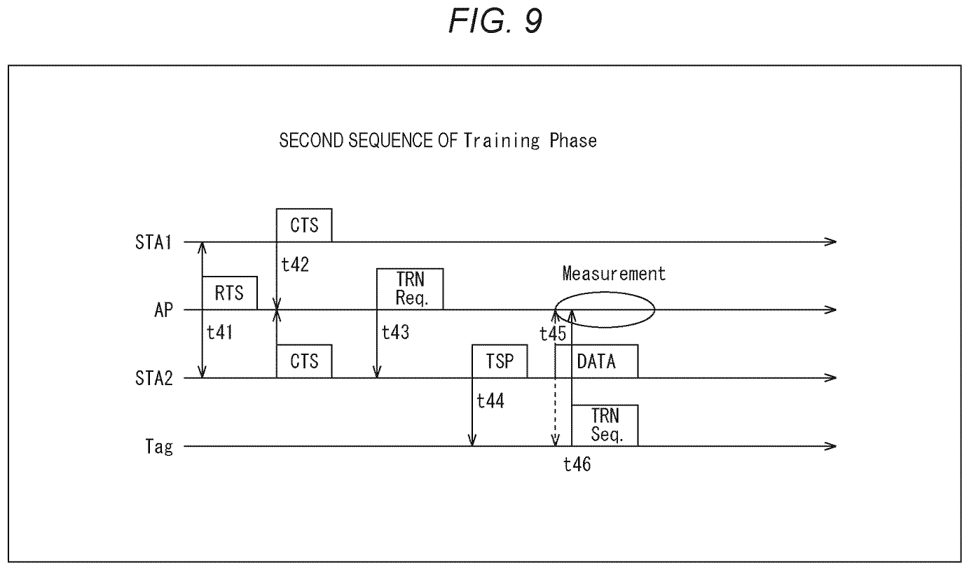

In the Training Phase, the AP measures reception quality of the STA2 in order to determine whether or not the STA2 can directly receive the BCS DATA from the Tag. A detailed sequence of the Training Phase will be described below with reference to FIG. 9.

In the ABCS Phase, the Tag transmits the BCS DATA to the STA2. At that time, the AP that has acquired transmission right determines a communication device that plays a role related to the communication of the backscatter signal from among the AP and the STAs. The role related to the communication of the backscatter signal includes a Power Supplier (first role) that transmits the RF signal (backscatter signal) to be reflected and/or absorbed by the Tag to generate the BCS DATA and a Reader (second role) that receives the BCS DATA.

That is, in the ABCS Phase, a communication device (first communication device) that plays the first role and a communication device (second communication device) that plays the second role are determined from among the AP and the STAs, and the ABCS communication is performed on the basis of the determined roles.

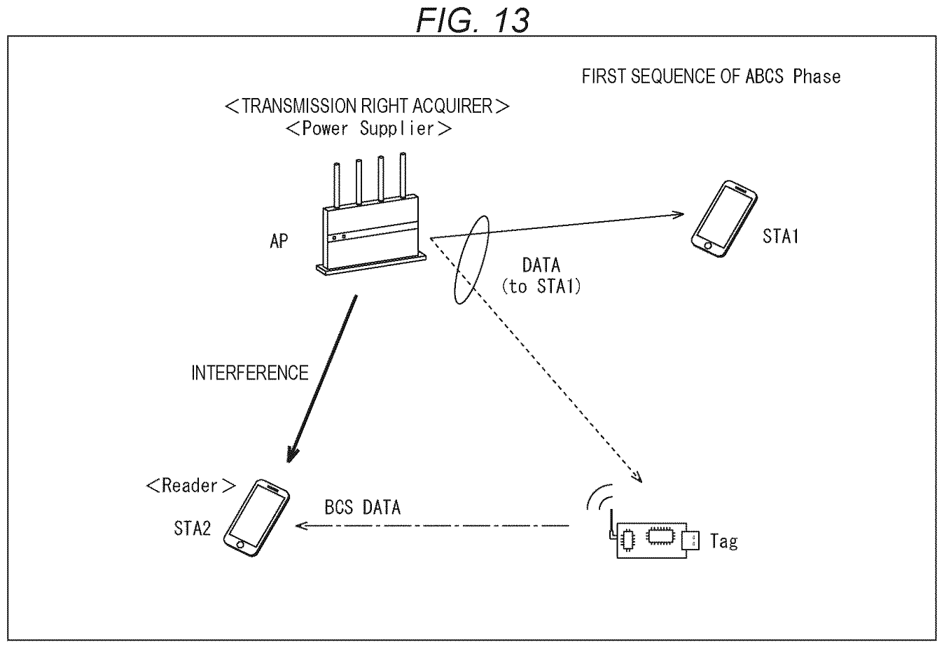

Note that, in the ABCS Phase, the Power Supplier and the Reader determined according to the Capability information of the AP and the STAs, the reception quality information indicating the reception quality measured in the Training Phase, traffic of the STA2 (for example, data to be transmitted) information, a remaining battery level, a type of the device that has acquired the transmission right, and the like are changed, and the operation sequence is also greatly changed accordingly. A detailed sequence will be described below with reference to FIG. 13 and the subsequent drawings.

### <Configuration Example of ABCS Capability Element Frame>

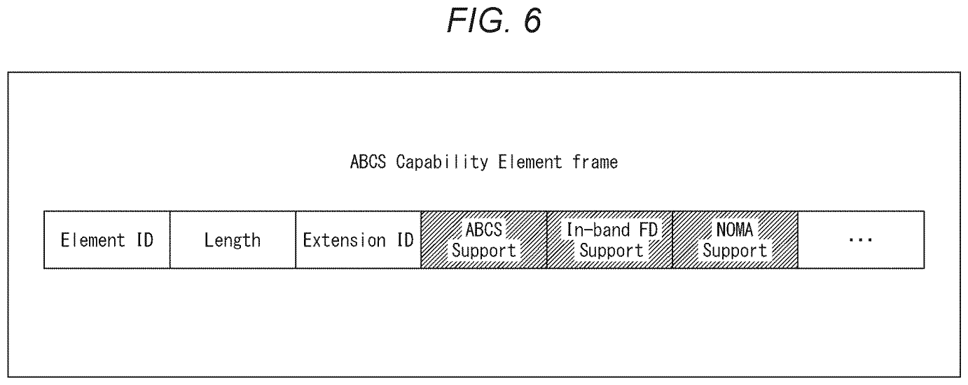

FIG. 6 is a diagram illustrating a configuration example of the ABCS Capability Element frame.

In FIG. 6, the ABCS Capability Element frame includes fields of Element ID, Length, Extension ID, ABCS Support, In-band FD Support, and NOMA Support. Note that, in FIG. 6, the hatched portions are portions relating to the new technique different from the conventional technique. Similarly, in the following drawings illustrating the configuration of the frame, the hatched portions indicate portions relating to the new technique different from the conventional technique.

The field of Element ID includes information indicating that the present Element is the ABCS Capability Element.

The Extension ID is used in combination with the Element ID as necessary. In the case where the Extension ID is used in combination with the Element ID, the field of Extension ID includes information indicating that the present Element is the ABCS Capability Element.

The field of Length includes information indicating the length of the present Element.

The field of ABCS Support includes information indicating ABCS support. The ABCS support indicates that, for example, a wireless communication unit for ABCS (for example, the ABCS unit 34 in FIG. 2) is included, the TSP can be transmitted, the BCS DATA can be received, and the like.

Note that, in the field of ABCS Support, a bit may be set in a case where both the transmission and the reception are supported, or a bit may be set in either a case where the transmission is supported or a case where the reception is supported. Furthermore, the field of ABCS Support may be configured separately for the transmission support and the reception support.

The field of In-band FD Support includes information indicating that transmission of a data signal and reception of the BCS DATA can be simultaneously performed by the In-band FD (that is, the interference canceller function is included).

The field of NOMA Support includes information indicating that simultaneous reception and simultaneous separation of the BCS DATA and other data signals are possible by the NOMA (that is, the interference canceller function is included).

Note that FIG. 6 illustrates an example in which the ABCS Capability Element is configured on the basis of an Element of IEEE802.11. The ABCS Capability Element of the present technology is not limited to the configuration of FIG. 6, and it is sufficient that at least the above-described information is included in the frame. Furthermore, in FIG. 6, the ABCS Capability Element frame is configured on the assumption of a MAC frame, but may be configured on the assumption of a TCP/IP frame as long as the above-described information is included.

### <ABCS Operating Mode Notification Frame>

FIG. 7 is a diagram illustrating a configuration example of an ABCS Operating Mode Notification frame.

In FIG. 7, the ABCS Operating Mode Notification frame includes fields of Category, Action, Dialog Token, and ABCS Operating Mode Notification.

The field of Category includes information indicating that the present Action frame is an ABCS-related frame.

The Action ID is used in combination with the Category. In the case where the Action ID is used in combination with the Category, the field of Action ID includes information indicating that the present Action frame is the ABCS Operating Mode Notification frame.

The field of Dialog Token includes information indicating a processing number of the present Action frame.

The field of ABCS Operating Mode Notification includes fields of Tag ID, ABCS Interval, and DATA Duration.

The field of Tag ID includes identification information of a transmission-side Tag of the BCS DATA. The identification information may be a MAC address or identification information that can be managed by the AP.

The field of ABCS Interval includes information indicating a time interval at which the BCS DATA is to be acquired (received) from the Tag. For example, in a case where the interval is set to 100 ms, an operation of starting the ABCS to acquire the BCS DATA from the Tag when a time passes around 100 ms from the previous BCS DATA acquisition timing is performed.

Note that the field of ABCS Interval may indicate a numerical value or may indicate index information based on a table defined in the standard.

The field of DATA Duration includes information indicating a time length of the BCS DATA. The Power Supplier needs to transmit at least a signal having a time length equal to or longer than the time length indicated in the field of DATA Duration.

Note that FIG. 7 illustrates an example in which the ABCS Operating Mode Notification frame is configured on the basis of an Action frame of IEEE802.11ax. The ABCS Operating Mode Notification frame of the present technology is not limited to the configuration of FIG. 7, and it is sufficient that at least the above-described information is included in the frame. These matters similarly apply to the following drawings illustrating a configuration of a frame.

### <First Sequence in Training Phase>

FIG. 8 is a diagram illustrating a first sequence in the Training Phase.

FIG. 8 illustrates a sequence in a case where the AP is the communication device in charge of the Power Supplier and the STA2 is the communication device in charge of the Reader.

Furthermore, FIG. 8 illustrates a sequence in a case where the AP acquires the transmission right and starts the processing. However, for example, an operation that the STA2 acquires the transmission right and requests the AP to perform similar processing may be performed. Note that the communication device that has acquired the transmission right is hereinafter referred to as a transmission right acquirer.

At timing t21, the AP transmits a Multi-User RTS frame (hereinafter referred to as an RTS frame (RTS in the drawing)) to the STA1, which is a transmission destination of the data signal, and the STA2 to which reception quality measurement for the BCS DATA is to be requested. The STA1 and the STA2 receive the RTS frame transmitted from the AP.

At timing t22, the STA1 and the STA2 transmit a CTS frame (CTS in the drawing), which is a response signal to the RTS frame, to the AP. The AP receives the CTS frame transmitted from the STA1 and the CTS frame transmitted from the STA2.

At timing t23, the AP transmits a TRN Request frame (TRN Req. in the drawing), which is a measurement request signal for requesting measurement of the reception quality, to the STA2, and notifies the STA2 of information regarding the reception quality measurement for the BCS DATA. The information regarding the reception quality measurement for the BCS DATA includes, for example, information for setting the STA2 as the Reader.

At timing t24, the AP transmits the TSP, which is a signal that allows the Tag to transmit the BCS DATA, to the Tag. The Tag receives the TSP, and checks that the TSP includes its own identification information and that training is to be performed.

At timing t25, the AP starts transmitting the data signal (DATA in the drawing) to the STA1. The STA1 and the Tag receive the data signal transmitted from the AP to the STA1.

At timing t26, the Tag transmits training BCS DATA (Training Sequence (TRN Seq. in the drawing)), which is a backscatter signal to which a known symbol is added, to the STA2. The STA2 receives the training BCS DATA transmitted from the Tag, and measures a Bit Error Rate (BER) or a Signal to Interference and Noise Ratio (SINR), which is the reception quality. Note that, if possible, t25 and t26 may be the same timing. Hereinafter, the same similarly applies to any sequence.

At timing t27, the STA2 transmits a TRN Response frame (TRN Resp. in the drawing), which is a measurement response signal including the reception quality information indicating the measured reception quality, to the AP. The AP receives the TRN Response frame and obtains the reception quality information.

As a result, the AP as the transmission right acquirer can determine the communication device that plays each role in the ABCS Phase, using the acquired reception quality information. The same similarly applies to a case where the STA is the transmission right acquirer. Thereafter, the sequence of FIG. 8 ends.

Note that the sequence in the Training Phase is not limited to the sequence in FIG. 8. For example, the STA2 may transmit some response signal (for example, a Block ACK frame or the like) after receiving the TRN Request frame. Furthermore, the STA2 may transmit a TRN Response frame after receiving some inductive signal (for example, a Trigger frame or the like) from the AP.

Furthermore, the STA2 may measure the reception quality in a state where a special function (for example, NOMA, beamforming, or beam steering) is performed. In this case, there may be some instruction from the AP to the STA2 about implementation of the special function or the like.

Moreover, in FIG. 8, one STA2 measures the reception quality, but a plurality of STAs may perform the measurement. In this case, a plurality of STAs may be designated in a Reader ID in an ABCS Request frame to be described below.

Note that, in the present embodiment, an example in which the communication device that plays each role is determined by the transmission right acquirer will be described below.

However, in a case where a server (not illustrated) is included in the wireless communication system, the communication device that plays each role may be determined by the server or the like.

### <Second Sequence in Training Phase>

FIG. 9 is a diagram illustrating a second sequence in the Training Phase.

The second sequence of FIG. 9 is different from the first sequence of FIG. 8 in that the communication device in charge of the AP is the Reader and the communication device in charge of the STA2 is the Power Supplier.

At timing t41, the AP transmits the RTS frame to the STA1 and the STA2 to which transmission of the data signal is to be requested. The STA1 and the STA2 receive the RTS frame transmitted from the AP.

At timing t42, the STA1 and the STA2 transmit the CTS frame to the AP. The AP receives the CTS frame transmitted from the STA1 and the CTS frame transmitted from the STA2.

At timing t43, the AP transmits the TRN Request frame, which is the measurement request signal for requesting measurement of the reception quality, to the STA2, and notifies the STA2 of the information regarding the reception quality measurement for the BCS DATA. In the case of FIG. 9, the information regarding the reception quality measurement for the BCS DATA includes, for example, information for setting the STA2 as the Power Supplier.

At timing t44, the STA2 transmits the TSP to the Tag. The Tag receives the TSP, and checks that the TSP includes its own identification information and that training is to be performed.

At timing t45, the STA2 starts transmitting the data signal to the AP. The AP and the Tag receive the data signal transmitted from the STA2 to the AP.

At timing t46, the Tag transmits the training BCS DATA, which is the backscatter signal to which a known symbol is added, to the AP. The AP receives the training BCS DATA transmitted from the Tag, and measures the BER or the SINR which is the reception quality. The AP acquires the reception quality information indicating the measured reception quality.

As a result, the AP can determine the communication device that plays each role in the ABCS Phase, using the acquired reception quality information. Thereafter, the sequence of FIG. 9 ends.

### <Configuration of ABCS TRN Request Frame>

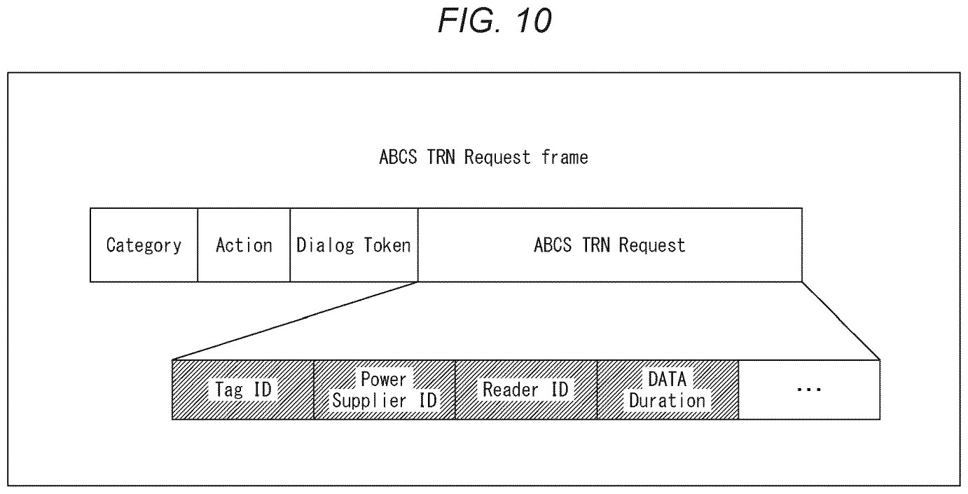

FIG. 10 is a diagram illustrating a configuration example of an ABCS TRN Request frame.

In FIG. 10, the ABCS TRN Request frame is different from the ABCS Operating Mode Notification frame in FIG. 7 in that the ABCS Operating Mode Notification field is replaced with an ABCS TRN Request field.

In FIG. 10, the ABCS TRN Request frame includes fields of Category, Action, Dialog Token, and ABCS TRN Request.

The field of Category includes information indicating that the present Action frame is an ABCS-related frame.

The Action is used in combination with the Category. The field of Action includes information indicating that the present Action frame is the ABCS TRN Request frame.

The field of Dialog Token includes information indicating a processing number of the present Action frame.

The field of ABCS TRN Request includes fields of Tag ID, Power Supplier ID, Reader ID, and DATA Duration.

The field of Tag ID includes identification information of a transmission-side Tag of the BCS DATA. The identification information may be a MAC address or identification information that can be managed by the AP.

The field of Power Supplier ID includes identification information of the communication device in charge of the Power Supplier that transmits a signal necessary for generating the training BCS DATA.

The field of Reader ID includes identification information of the communication device in charge of the Reader that receives the training BCS DATA and measures reception quality.

The identification information of the communication device in charge of the Power Supplier and the identification information of the communication device in charge of the Reader may be MAC addresses, Association IDs (AIDs), identification information that can be managed by the AP, or the like.

The field of DATA Duration includes information indicating a time length of the BCS DATA.

### <Configuration of ABCS TRN Response Frame>

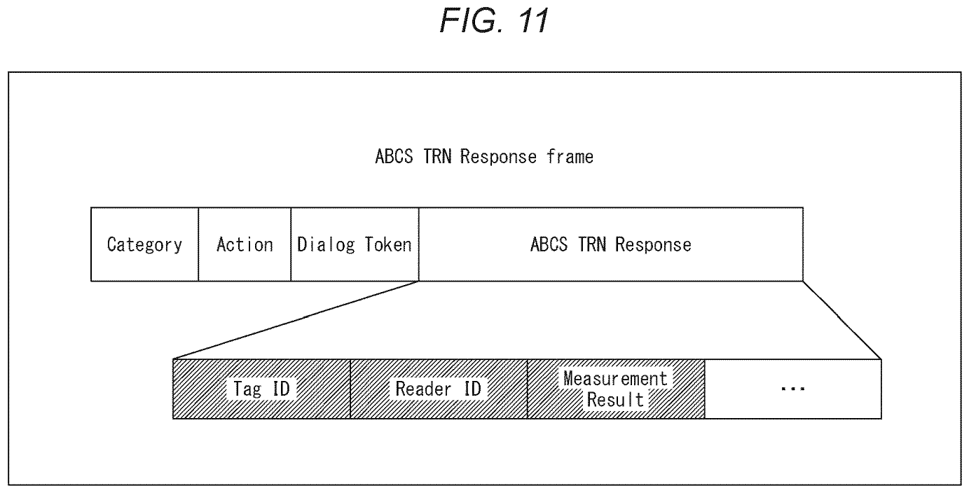

FIG. 11 is a diagram illustrating a configuration example of an ABCS TRN Response frame.

In FIG. 11, the ABCS TRN Response frame is different from the ABCS Operating Mode Notification frame in FIG. 7 in that the ABCS Operating Mode Notification field is replaced with an ABCS TRN Response field.

In FIG. 11, the ABCS TRN Response frame includes fields of Category, Action, Dialog Token, and ABCS TRN Response.

The field of Category includes information indicating that the present Action frame is an ABCS-related frame.

The Action is used in combination with the Category. The field of Action includes information indicating that the present Action frame is the ABCS TRN Response frame.

The field of Dialog Token includes information indicating a processing number of the present Action frame.

The field of ABCS TRN Response includes fields of Tag ID, Reader ID, and Measurement Result.

The field of Tag ID includes identification information of a transmission-side Tag of the BCS DATA. The identification information may be a MAC address or identification information that can be managed by the AP.

The field of Reader ID includes identification information of the Reader that receives the training BCS DATA and measures the reception quality. The identification information of the Reader ID may be a MAC address, an Association ID (AID), identification information that can be managed by the AP, or the like.

The field of Measurement Result includes reception quality information indicating the measured reception quality of the BCS DATA. The reception quality information may be the BER or the SINR, or may be both pieces of the information.

### <Configuration Example of TSP>

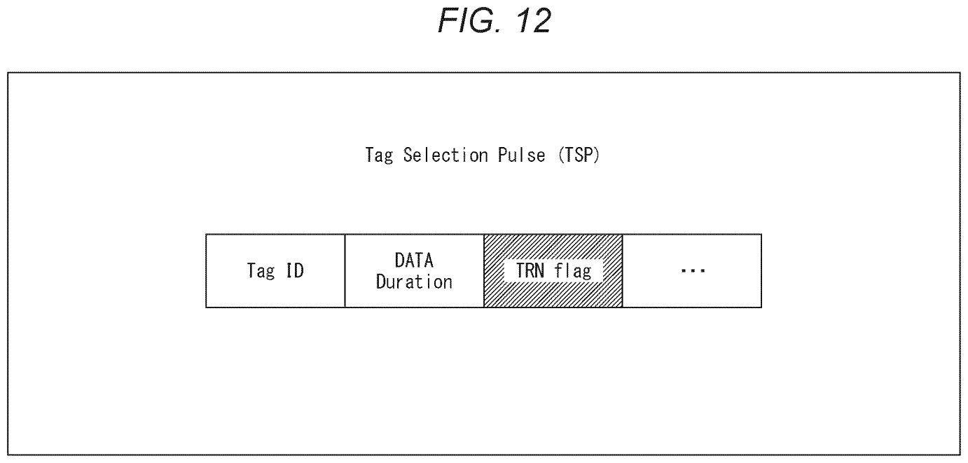

FIG. 12 is a diagram illustrating a configuration example of the TSP.

In FIG. 12, the TSP includes fields of Tag ID, DATA Duration, and TRN flag.

The field of Tag ID includes identification information of a transmission-side Tag of the BCS DATA. The identification information may be a MAC address or identification information that can be managed by the AP.

The field of DATA Duration includes information indicating a time length of the BCS DATA.

The field of TRN Flag includes information indicating whether or not to transmit a known signal for training. In a case where the field of TRN Flag is “1”, the Tag transmits the BCS DATA in a form of adding known sequence information to a subsequent signal. In a case where the field of TRN Flag is “0”, the Tag transmits the BCS DATA in a form of adding its own information to be transmitted (for example, sensor data or the like).

### <Details of ABCS Phase>

As described above, the sequence of the ABCS Phase is different depending on which communication device is in charge of each of the transmission right acquirer, the Power Supplier, and the Reader. Hereinafter, each sequence example will be described, and then how each sequence is selected and executed will be described. Note that, in any sequence, the STA2 desires to acquire the BCS DATA, and the STA2 directly or indirectly acquires the BCS DATA. Hereinafter, each sequence example will be described.

### <First Sequence of ABCS Phase>

FIG. 13 is a diagram illustrating a signal flow among the communication devices when a first sequence of the ABCS Phase is performed.

FIG. 13 illustrates the signal flow among the communication devices when the first sequence is performed in a case where the communication devices in charge of the transmission right acquirer, the Power Supplier, and the Reader are the AP, the AP, and the STA2, respectively.

The AP, which is the communication device in charge of the Power Supplier, transmits the TSP to the Tag and starts transmitting the data signal (DATA in the drawing) to the STA1 as indicated by the solid arrow.

As indicated by the dashed arrow, the Tag receives the data signal transmitted from the AP to the STA1. The Tag generates the BCS DATA, which is the backscatter signal to which data information (for example, sensor data or the like) to be transmitted is added, on the basis of the received data signal, and transmits the generated BCS DATA to the STA2 as indicated by the dashed-dotted arrow.

The STA2, which is the communication device in charge of the Reader, receives the BCS DATA.

Note that, in the first sequence, the STA2 observes the data signal transmitted from the AP to the STA1 as an interference wave as indicated by the thick arrow, and thus at least needs to satisfy sufficient reception quality of the BCS DATA.

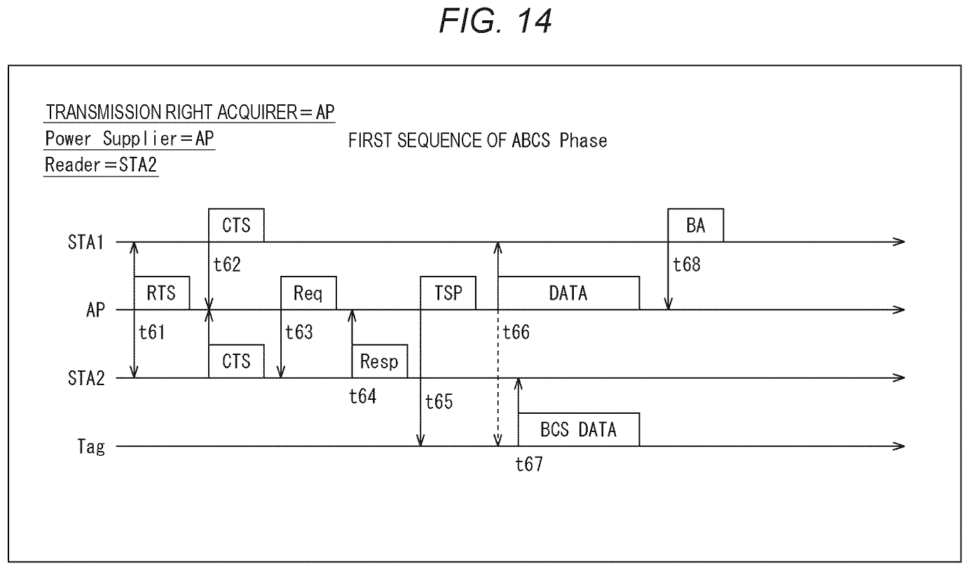

FIG. 14 is a diagram illustrating the first sequence of the ABCS Phase.

Hereinafter, the first sequence will be described in detail, but in the detailed description of the first sequence of FIG. 14, FIG. 13 described above is appropriately referred to.

At timing t61 in FIG. 14, the AP as the transmission right acquirer transmits the RTS frame to the STA1 as the transmission destination of the data signal and the STA2 as the reception side of the BCS DATA. The STA1 and the STA2 receive the RTS frame.

At timing t62, the STA1 and the STA2 transmit the CTS frame to the AP. The AP receives the CTS frame transmitted from the STA1 and the CTS frame transmitted from the STA2.

At timing t63, the AP transmits the ABCS Request frame to the STA2, and notifies the STA2 of information regarding the Tag, the Power Supplier, and the Reader. The ABCS Request frame is a role request signal for requesting execution of at least one role of the Power Supplier or the Reader. The STA2 receives the ABCS Request frame.

At timing t64, the STA2 determines its own operation on the basis of the ABCS Request frame, and transmits an ABCS Response frame, which is a response signal to the ABCS Request frame, to the AP. The ABCS Response frame includes information indicating whether or not the operation in the requested role is possible.

After receiving the ABCS Response frame as a response signal from the STA2, the AP transmits the TSP to the Tag at timing t65.

The Tag that has received the TSP checks that its own identification information is included in the TSP.

At timing t66, the AP starts transmitting the data signal to the STA1 (the solid arrow in FIG. 13).

The Tag receives the data signal transmitted from the AP to the STA1 (the dashed arrow in FIG. 13), and transmits the BCS DATA, which is the backscatter signal to which data information to be transmitted is added, to the STA2 at timing t67 (the dashed-dotted arrow in FIG. 13). The STA2 receives the BCS DATA transmitted from the Tag. Note that, if possible, t66 and t67 may be the same timing. Hereinafter, the same similarly applies to any sequence.

Meanwhile, the STA1, which has received the data signal transmitted from the AP, transmits the Block ACK frame (BA in the drawing), which is a reception confirmation response signal, to the AP at timing t68. Thereafter, the first sequence of FIG. 14 ends.

Note that, as described above with reference to FIG. 13, in the first sequence, the STA2 observes the data signal transmitted from the AP to the STA1 as an interference wave, and thus at least needs to satisfy sufficient reception quality of the BCS DATA.

In order to satisfy sufficient reception quality, the STA2 may perform the above-described reception quality measurement in a state of using a multi-antenna function such as NOMA or beamforming/beam steering. Furthermore, in a case where the AP knows in advance that the STA2 has the multi-antenna function, the above-described reception quality measurement may be omitted.

Moreover, in the first sequence, the AP may transmit a carrier wave having no information instead of the data signal for the STA1. Furthermore, in the first sequence, the AP may transmit the data signal to the STA2 instead of the STA1. In this case, the STA2 needs to simultaneously receive and acquire the data signal from the AP and the BCS DATA from the Tag, and thus the STA2 needs to support NOMA. Therefore, in the case where the AP transmits the data signal to the STA2, the requirement becomes stricter than that in a case where the AP transmits the data signal to another STA.

### <Second Sequence of ABCS Phase>

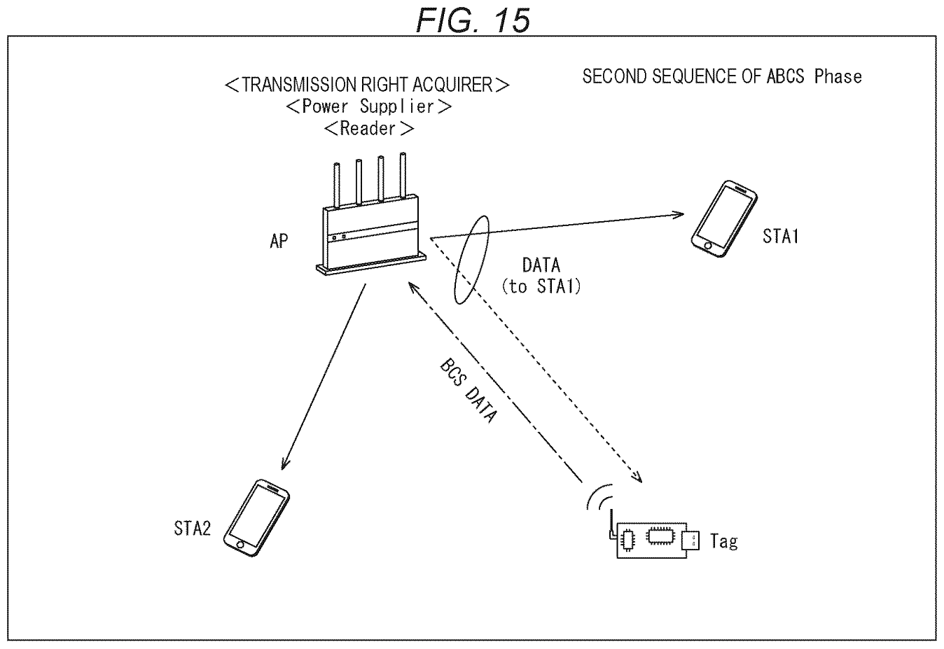

FIG. 15 is a diagram illustrating a signal flow among the communication devices when a second sequence of the ABCS Phase is performed.

FIG. 15 illustrates the signal flow among the communication devices when the second sequence is performed in a case where the communication devices in charge of the transmission right acquirer, the Power Supplier, and the Reader are all APs.

The AP, which is the communication device in charge of the Power Supplier, transmits the TSP to the Tag and starts transmitting the data signal to the STA1 as indicated by the solid arrow.

As indicated by the dashed arrow, the Tag receives the data signal transmitted from the AP to the STA1. The Tag generates the BCS DATA, which is the backscatter signal to which data information to be transmitted is added, on the basis of the received data signal, and transmits the generated BCS DATA to the AP as indicated by the dashed-dotted arrow.

The AP, which is the communication device in charge of the Reader, receives the BCS DATA and transmits the received BCS DATA to the STA2.

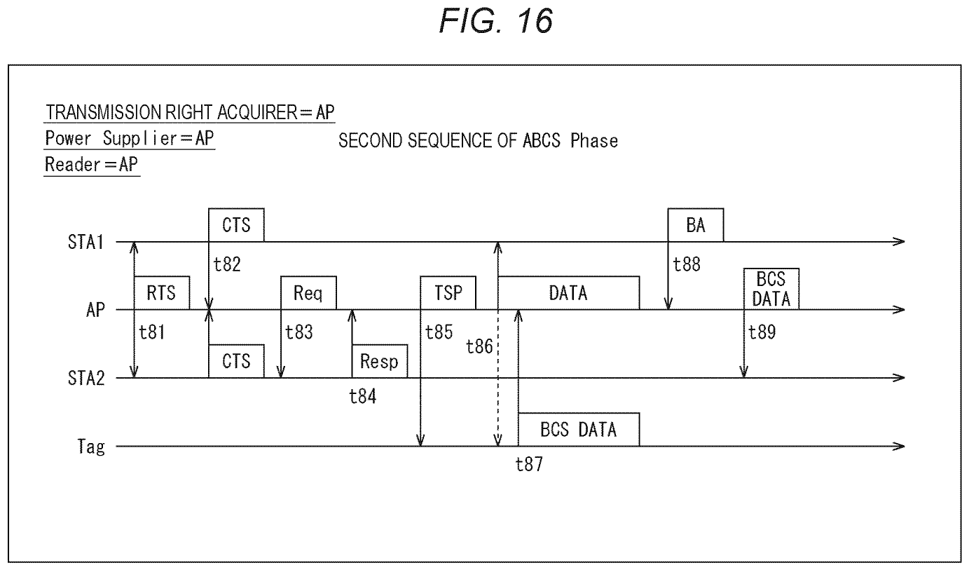

FIG. 16 is a diagram illustrating the second sequence of the ABCS Phase.

Hereinafter, the second sequence will be described in detail, but in the detailed description of the second sequence of FIG. 16, FIG. 15 described above is appropriately referred to.

Since processing at timing t81 to S84 in FIG. 16 is similar to the processing at the timing t61 to t64 in FIG. 14, description thereof will be omitted.

After receiving the ABCS Response frame as a response signal from the STA2, the AP transmits the TSP to the Tag at timing t85.

The Tag that has received the TSP checks that its own identification information is included in the TSP.

At timing t86, the AP starts transmitting the data signal to the STA1 (the solid arrow in FIG. 15).

The Tag receives the data signal transmitted from the AP to the STA1 (the dashed arrow in FIG. 15), and transmits the BCS DATA, which is the backscatter signal to which data information to be transmitted is added, to the AP at timing t87 (the dashed-dotted arrow in FIG. 15). The AP receives the BCS DATA.

Meanwhile, the STA1, which has received the data signal transmitted from the AP, transmits the BA, which is a reception confirmation response signal, to the AP at timing t68.

The AP receives the BA and transmits the BCS DATA received from the Tag to the STA2 at timing t89. The STA2 can indirectly acquire the BCS DATA by receiving the BCS DATA transmitted from the AP. Thereafter, the second sequence of FIG. 16 ends.

The second sequence of FIG. 16 is different from the first sequence of FIG. 14 in that the AP simultaneously receives the BCS DATA signal from the Tag while transmitting the data signal after transmitting the TSP, and then transmits the received BCS DATA to the STA2.

Note that, in the second sequence, since the AP needs to simultaneously transmit the data signal and receive the BCS DATA, the AP needs to support the In-band FD.

Furthermore, also in the second sequence, the AP may transmit a carrier wave having no information instead of the data signal for the STA1. Moreover, also in the second sequence, the AP may transmit the data signal to the STA2 instead of the STA1.

### <Third Sequence of ABCS Phase>

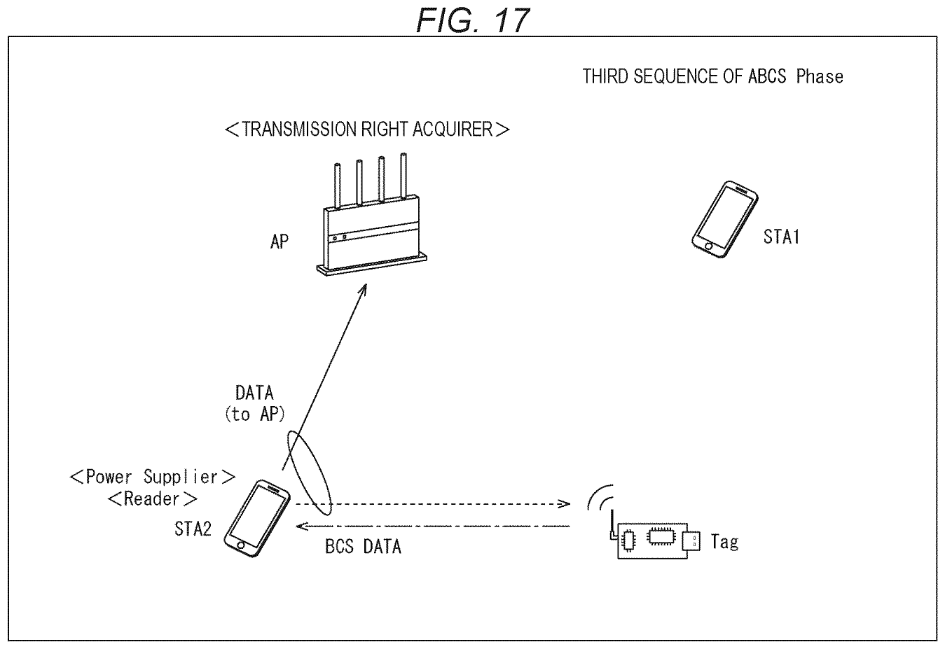

FIG. 17 is a diagram illustrating a signal flow among the communication devices when a third sequence of the ABCS Phase is performed.

FIG. 17 illustrates the signal flow among the communication devices when the third sequence is performed in a case where the communication devices in charge of the transmission right acquirer, the Power Supplier, and the Reader are the AP, the STA2, and the STA2, respectively.

The STA2, which is the communication device in charge of the Power Supplier, transmits the TSP to the Tag and starts transmitting the data signal to the AP as indicated by the solid arrow.

As indicated by the dashed arrow, the Tag receives the data signal transmitted from the STA2 to the AP. The Tag generates the BCS DATA, which is the backscatter signal to which data information to be transmitted is added, on the basis of the received data signal, and transmits the generated BCS DATA to the STA2 as indicated by the dashed-dotted arrow.

The STA2, which is the communication device in charge of the Reader, receives the BCS DATA.

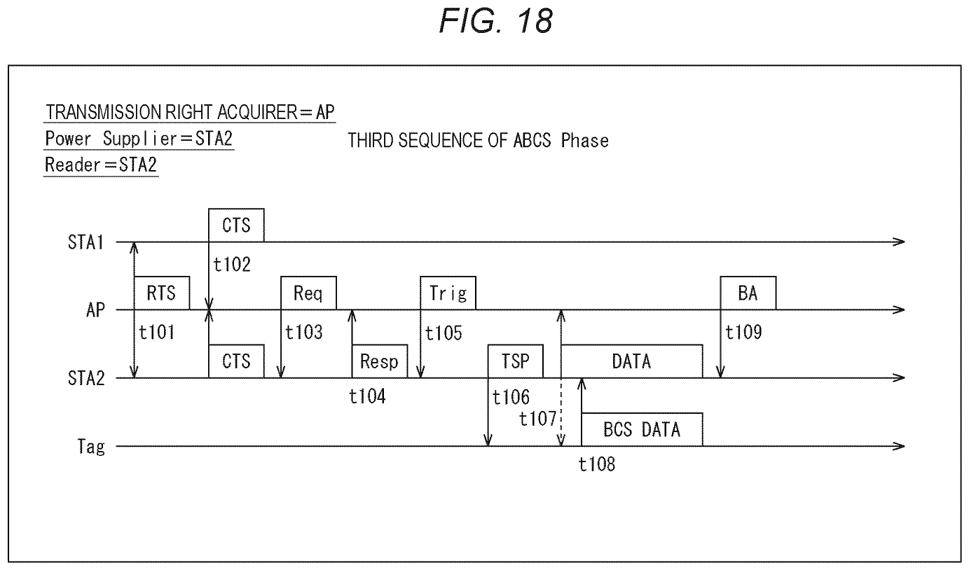

FIG. 18 is a diagram illustrating the third sequence of the ABCS Phase.

Hereinafter, the third sequence will be described in detail, but in the detailed description of the third sequence of FIG. 18, FIG. 17 described above is appropriately referred to.

Since processing at the timing t101 to S104 in FIG. 18 is similar to the processing at the timing t61 to t64 in FIG. 14, description thereof will be omitted.

After receiving the ABCS Response frame, which is a response signal, from the STA2, the AP transmits the Trigger frame, which is a signal inducing transmission of the data signal to the AP itself, to the STA2 at timing t105.

The STA2 receives the Trigger frame and transmits the TSP to the Tag at timing t106.

The Tag that has received the TSP checks that its own identification information is included in the TSP.

At timing t107, the STA2 starts transmitting the data signal to the AP (the solid arrow in FIG. 17).

The Tag receives the data signal transmitted from the STA2 to the AP (the dashed arrow in FIG. 17), and transmits the BCS DATA, which is the backscatter signal to which data information to be transmitted is added, to the STA2 at timing t108 (the dashed-dotted arrow in FIG. 17). The STA2 receives the BCS DATA.

Meanwhile, the AP, which has received the data signal transmitted from the STA2, transmits the BA, which is a reception confirmation response signal, to the STA2 at timing t109. Thereafter, the third sequence of FIG. 18 ends.

The third sequence in FIG. 18 is different from the first sequence in FIG. 14 in that the AP transmits the Trigger frame to the STA2 to induce transmission of the data signal to the STA2 itself after transmitting the ABCS Request frame and the ABCS Response frame, between the AP and the STA2. After receiving the Trigger frame and transmitting the TSP to the Tag, the STA2 receives the BCS DATA transmitted from the Tag while transmitting the data signal to the AP.

Note that, in the third sequence, since the STA2 needs to simultaneously transmit the data signal and receive the BCS DATA, the STA2 needs to support the In-band FD.

Furthermore, in the third sequence, the STA2 may transmit a carrier wave having no information instead of the data signal for the AP. Note that, in this case, the STA2 needs to consider a situation in which the STA2 is restricted to refrain from unnecessary transmission on the basis of its own remaining battery level or the like.

### <Fourth Sequence of ABCS Phase>

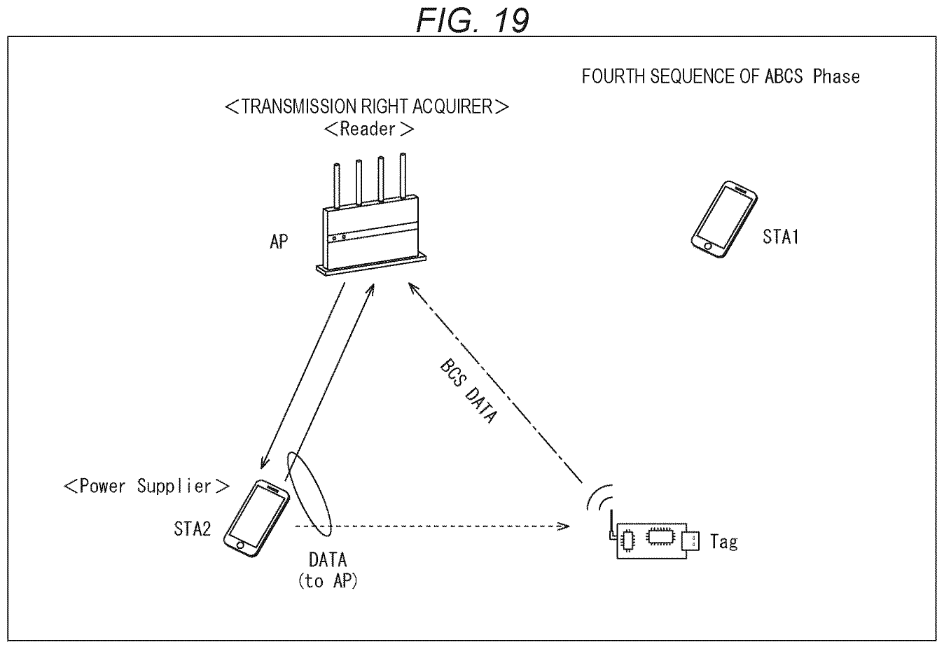

FIG. 19 is a diagram illustrating a signal flow among the communication devices when a fourth sequence of the ABCS Phase is performed.

FIG. 19 illustrates the signal flow among the communication devices when the fourth sequence is performed in a case where the communication devices in charge of the transmission right acquirer, the Power Supplier, and the Reader are the AP, the STA2, and the AP, respectively.

The STA2, which is the communication device in charge of the Power Supplier, transmits the TSP to the Tag and starts transmitting the data signal to the AP as indicated by the solid arrow.

As indicated by the dashed arrow, the Tag receives the data signal transmitted from the STA2 to the AP. The Tag generates the BCS DATA, which is the backscatter signal to which data information to be transmitted is added, on the basis of the received data signal, and transmits the generated BCS DATA to the AP as indicated by the dashed-dotted arrow.

The AP, which is the communication device in charge of the Reader, receives the BCS DATA and transmits the received BCS DATA to the STA2.

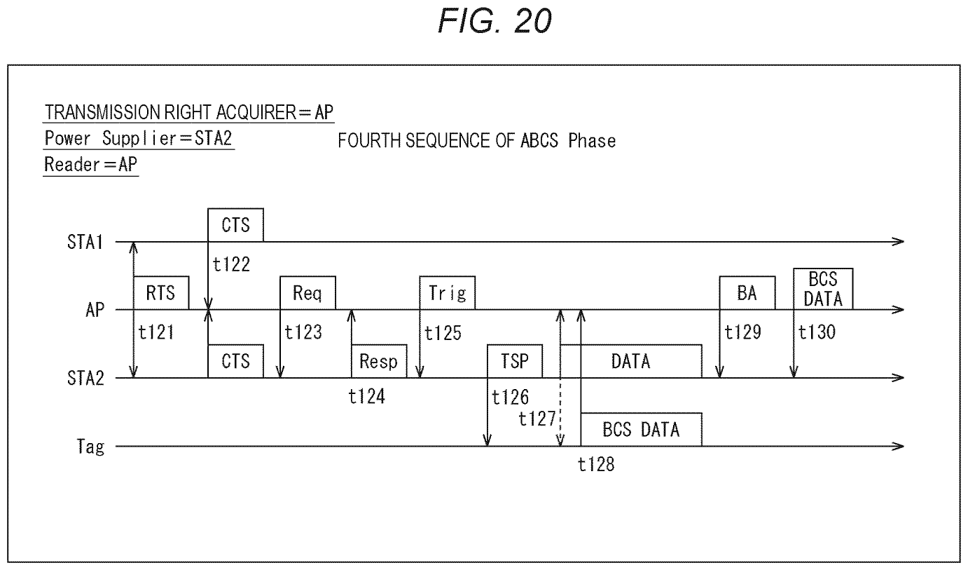

FIG. 20 is a diagram illustrating the fourth sequence of the ABCS Phase.

Hereinafter, the fourth sequence will be described in detail, but in the detailed description of the fourth sequence in FIG. 20, FIG. 19 described above is appropriately referred to.

Since processing at the timing t121 to S124 in FIG. 20 is similar to the processing at the timing t61 to t64 in FIG. 14, description thereof will be omitted.

After receiving the ABCS Response frame, which is a response signal, from the STA2, the AP transmits the Trigger frame, which is a signal inducing transmission of the data signal to the AP itself, to the STA2 at timing t125.

The STA2 receives the Trigger frame and transmits the TSP to the Tag at timing t126.

The Tag that has received the TSP checks that its own identification information is included in the TSP.

At timing t127, the STA2 starts transmitting the data signal to the AP (the solid arrow in FIG. 19).

The Tag receives the data signal transmitted from the STA2 to the AP (the dashed arrow in FIG. 19), and transmits the BCS DATA, which is the backscatter signal to which data information to be transmitted is added, to the AP at timing t128 (the dashed-dotted arrow in FIG. 19). The AP receives the BCS DATA.

Meanwhile, the AP, which has received the data signal transmitted from the STA2, transmits the BA, which is a reception confirmation response signal, to the STA2 at timing t129.

At timing t130, the AP transmits the BCS DATA received from the Tag to the STA2. The STA2 can indirectly acquire the BCS DATA by receiving the BCS DATA transmitted from the AP. Thereafter, the fourth sequence of FIG. 20 ends.

The fourth sequence of FIG. 20 is different from the first sequence of FIG. 14 in that after the STA2 transmits the TSP, the AP receives the BCS DATA, and then transmits the received BCS DATA to the STA2.

Note that, in the fourth sequence, since the AP needs to simultaneously receive the data signal transmitted from the STA2 and receive the BCS DATA transmitted from the Tag, the AP needs to support the NOMA.

Furthermore, in the fourth sequence, the STA2 may transmit a carrier wave having no information instead of the data signal for the AP. Note that, in this case, since the AP observes the signal transmitted from the STA2 as an interference wave, at least either the AP has a multi-antenna function such as NOMA or beamforming/beam steering or satisfies sufficient reception quality of the BCS DATA.

Furthermore, in this case, the STA2 needs to consider a situation in which the STA2 is restricted to refrain from unnecessary transmission on the basis of its own remaining battery level or the like.

### <Fifth Sequence of ABCS Phase>

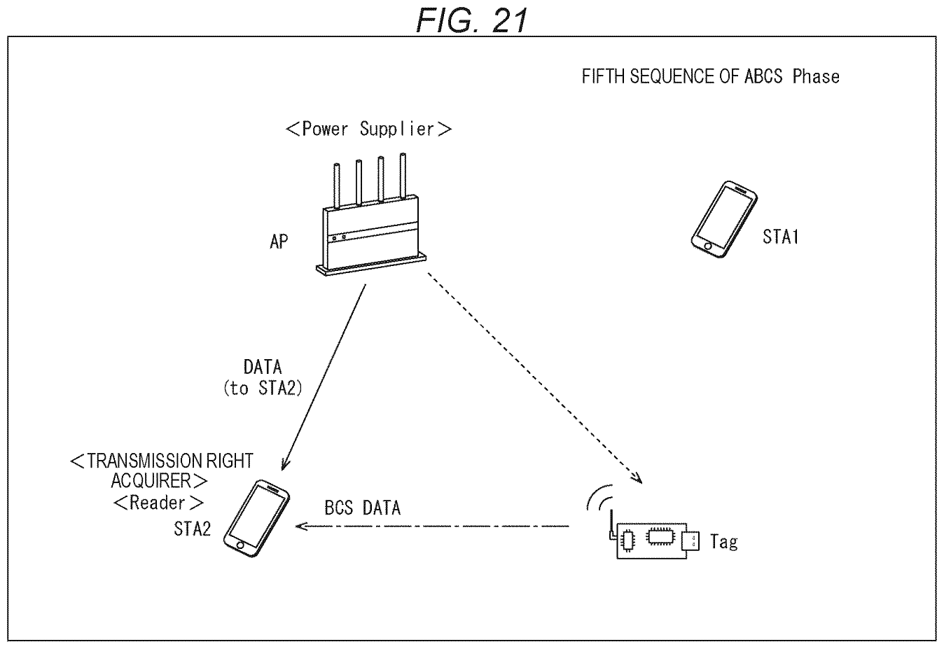

FIG. 21 is a diagram illustrating a signal flow among the communication devices when a fifth sequence of the ABCS Phase is performed.

FIG. 21 illustrates the signal flow among the communication devices when the fifth sequence is performed in a case where the communication devices in charge of the transmission right acquirer, the Power Supplier, and the Reader are the STA2, the AP, and the STA2, respectively.

The AP, which is the communication device in charge of the Power Supplier, transmits the TSP to the Tag and starts transmitting the data signal to the STA2 as indicated by the solid arrow.

As indicated by the dashed arrow, the Tag receives the data signal transmitted from the AP to the STA2. The Tag generates the BCS DATA, which is the backscatter signal to which data information to be transmitted is added, on the basis of the received data signal, and transmits the generated BCS DATA to the STA2 as indicated by the dashed-dotted arrow.

The STA2, which is the communication device in charge of the Reader, receives the BCS DATA.

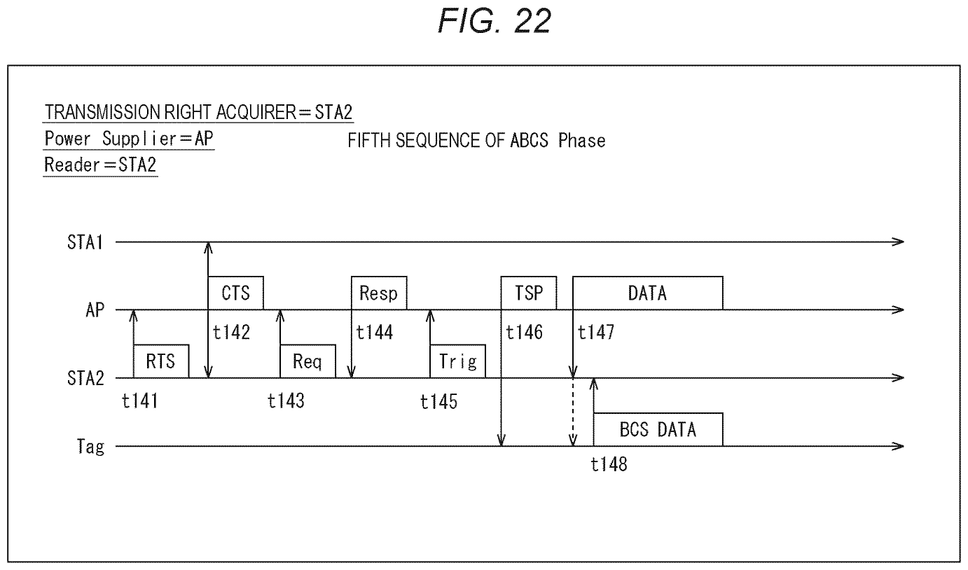

FIG. 22 is a diagram illustrating the fifth sequence of the ABCS Phase.

Hereinafter, the fifth sequence will be described in detail, but in the detailed description of the fifth sequence in FIG. 22, FIG. 21 described above is appropriately referred to.

At timing t141 in FIG. 22, the STA2 as the transmission right acquirer transmits the RTS frame to the AP as a requested destination of transmission of the data signal. The AP receives the RTS frame.

At timing t142, the AP transmits the CTS frame to the STA1 and the STA2. The STA1 and the STA2 receive the CTS frame.

At timing t143, the STA2 transmits the ABCS Request frame to the AP, and notifies the AP of information regarding the Tag and the BCS DATA.

At timing t144, the AP transmits the ABCS Response frame, which is a response signal to the ABCS Request frame, to the STA2.

After receiving the ABCS Response frame, which is a response signal, from the AP, the STA2 transmits the Trigger frame, which is a signal inducing transmission of the data signal to the STA2 itself, to the AP at timing t145.

The AP receives the Trigger frame and transmits the TSP to the Tag at timing t146.

The Tag that has received the TSP checks that its own identification information is included in the TSP.

At timing t147, the AP starts transmitting the data signal to the STA2 (the solid arrow in FIG. 21).

The Tag receives the data signal transmitted from the AP to the STA2 (the dashed arrow in FIG. 21), and transmits the BCS DATA, which is the backscatter signal to which data information to be transmitted is added, to the STA2 at timing t148 (the dashed-dotted arrow in FIG. 21). The STA2 receives the data signal transmitted from the AP and the BCS DATA transmitted from the Tag.

Thereafter, the fifth sequence of FIG. 22 ends.

In the fifth sequence, since the STA2 needs to simultaneously receive the data signal transmitted from the AP and receive the BCS DATA transmitted from the Tag, the STA2 needs to support the NOMA.

Furthermore, in the fifth sequence, since the AP transmits the data signal by a method of responding to the request signal transmitted from the STA2, the transmission destination is limited to the STA2 in the case where the AP transmits the data signal.

Moreover, in the fifth sequence, the STA2 may transmit a carrier wave having no information instead of the data signal for the AP. Note that, in this case, the STA2 observes the signal transmitted from the AP as an interference wave, and thus at least needs to satisfy sufficient reception quality of the BCS DATA. In any case, in a case where the AP transmits a carrier wave having no information, a necessary requirement is relaxed as compared with a case where the AP transmits the data signal to the STA2.

In order to satisfy sufficient reception quality, the STA2 may perform the above-described reception quality measurement in a state of using a multi-antenna function such as NOMA or beamforming/beam steering. In a case where it is known in advance that the STA2 has such functions, the above-described reception quality measurement may be omitted.

### <Sixth Sequence of ABCS Phase>

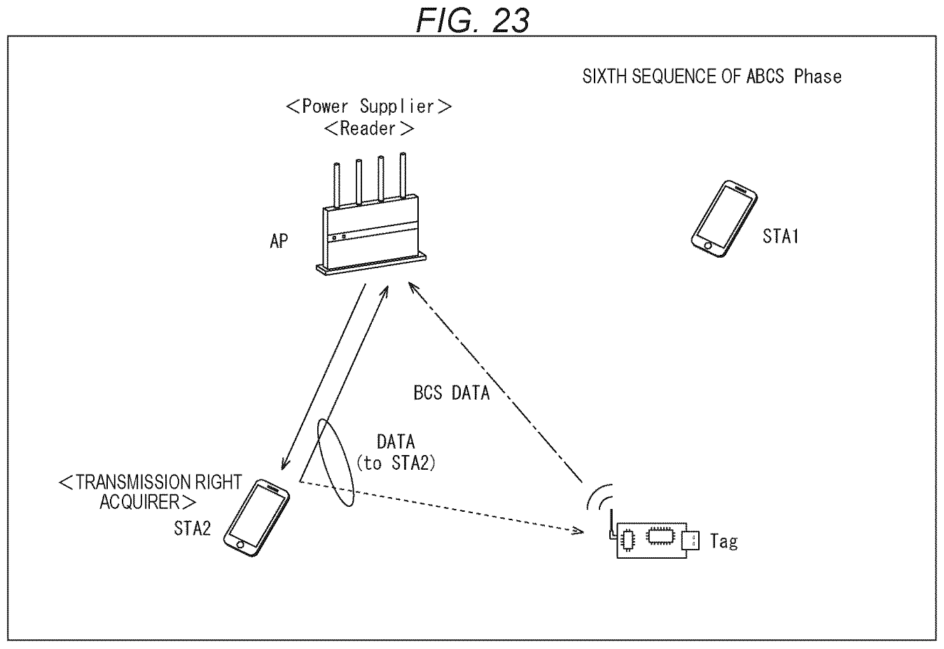

FIG. 23 is a diagram illustrating a signal flow among the communication devices when a sixth sequence of the ABCS Phase is performed.

FIG. 23 illustrates the signal flow among the communication devices when the sixth sequence is performed in a case where the communication devices in charge of the transmission right acquirer, the Power Supplier, and the Reader are the STA2, the AP, and the AP, respectively.

The AP, which is the communication device in charge of the Power Supplier, transmits the TSP to the Tag and starts transmitting the data signal to the STA2 as indicated by the solid arrow.

As indicated by the dashed arrow, the Tag receives the data signal transmitted from the AP to the STA2. The Tag generates the BCS DATA, which is the backscatter signal to which data information to be transmitted is added, on the basis of the received data signal, and transmits the generated BCS DATA to the AP as indicated by the dashed-dotted arrow.

The AP, which is the communication device in charge of the Reader, receives the BCS DATA and transmits the received BCS DATA to the STA2.

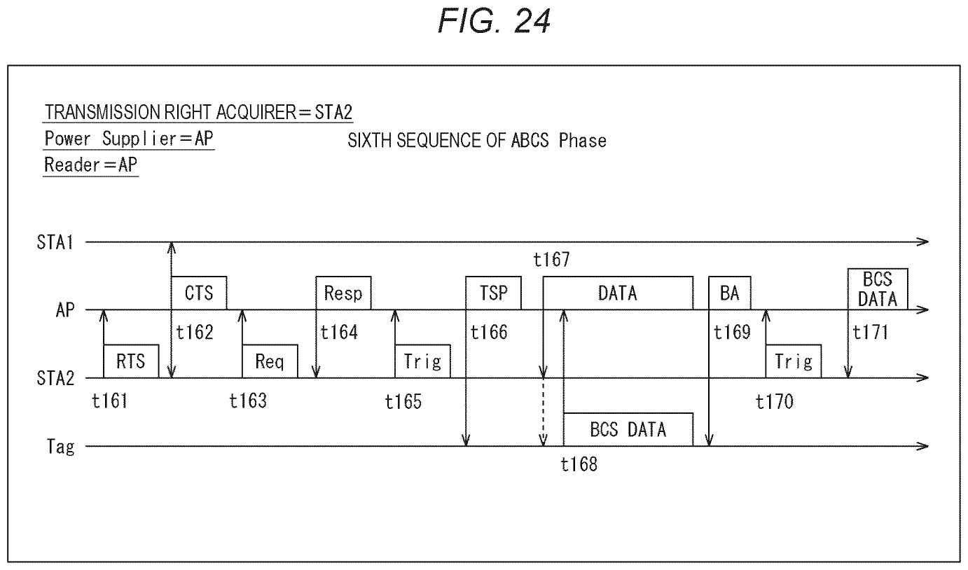

FIG. 24 is a diagram illustrating the sixth sequence of the ABCS Phase.

Hereinafter, the sixth sequence will be described in detail. In the detailed description of the sixth sequence of FIG. 24, FIG. 23 described above is referred to as appropriate.

Since processing at the timing t161 to S164 in FIG. 24 is similar to the processing at the timing t141 to 144 in FIG. 12, description thereof will be omitted.

After receiving the ABCS Response frame, which is a response signal, from the AP, the STA2 transmits the Trigger frame, which is a signal inducing transmission of the data signal to the STA2 itself, to the AP at timing t165.

The AP receives the Trigger frame and transmits the TSP to the Tag at timing t166.

The Tag that has received the TSP checks that its own identification information is included in the TSP.

At timing t167, the AP starts transmitting the data signal to the STA2 (the solid arrow in FIG. 23).

The Tag receives the data signal transmitted from the AP to the STA2 (the dashed arrow in FIG. 23), and transmits the BCS DATA, which is the backscatter signal to which data information to be transmitted is added, to the AP at timing t168 (the dashed-dotted arrow in FIG. 23). The AP receives the BCS DATA.

Meanwhile, the AP, which has received the data signal transmitted from the STA2, transmits the BA, which is a reception confirmation response signal, to the STA2 at timing t169. The STA2, which has received the BA transmitted from the AP, transmits the Trigger signal for inducing transmission of the BCS DATA to the AP at timing t170.

The AP receives the Trigger signal and transmits the BCS DATA to the STA2 at timing t171. The STA2 receives the BCS DATA transmitted from the AP. Thereafter, the sixth sequence of FIG. 24 ends.

The sixth sequence of FIG. 24 is different from the fifth sequence of FIG. 22 in that the AP simultaneously receives the BCS DATA from the Tag while transmitting the data signal after transmitting the TSP, and then transmits the received BCS DATA to the STA2.

Note that, in the sixth sequence, since the AP needs to simultaneously transmit the data signal and receive the BCS DATA transmitted from the Tag, the AP needs to support the In-band FD.

Furthermore, in the sixth sequence, since the AP transmits the data signal by a method of responding to the request signal transmitted from the STA2, the transmission destination is limited to the STA2 in the case where the AP transmits the data signal.

Moreover, in the sixth sequence, the AP may transmit a carrier wave having no information instead of the data signal for the STA2.

### <Seventh Sequence of ABCS Phase>

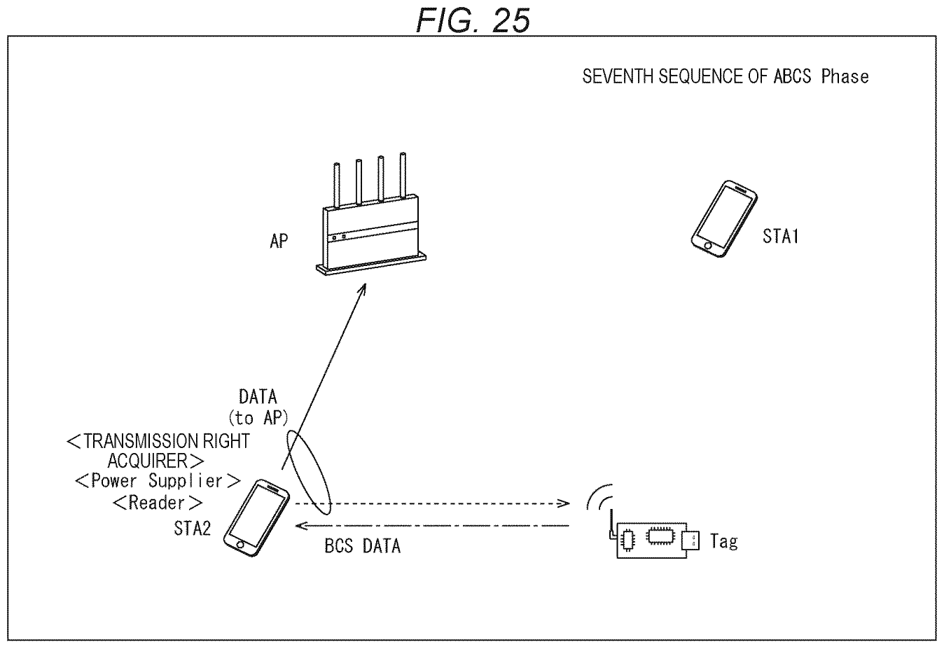

FIG. 25 is a diagram illustrating a signal flow among the communication devices when a seventh sequence of the ABCS Phase is performed.

FIG. 25 illustrates the signal flow among the communication devices when the seventh sequence is performed in a case where the communication devices in charge of the transmission right acquirer, the Power Supplier, and the Reader are all STA2s.

The STA2, which is the communication device in charge of the Power Supplier, transmits the TSP to the Tag and starts transmitting the data signal to the AP as indicated by the solid arrow.

As indicated by the dashed arrow, the Tag receives the data signal transmitted from the STA2 to the AP. The Tag generates the BCS DATA, which is the backscatter signal to which data information to be transmitted is added, on the basis of the received data signal, and transmits the generated BCS DATA to the STA2 as indicated by the dashed-dotted arrow.

The STA2, which is the communication device in charge of the Reader, receives the BCS DATA.

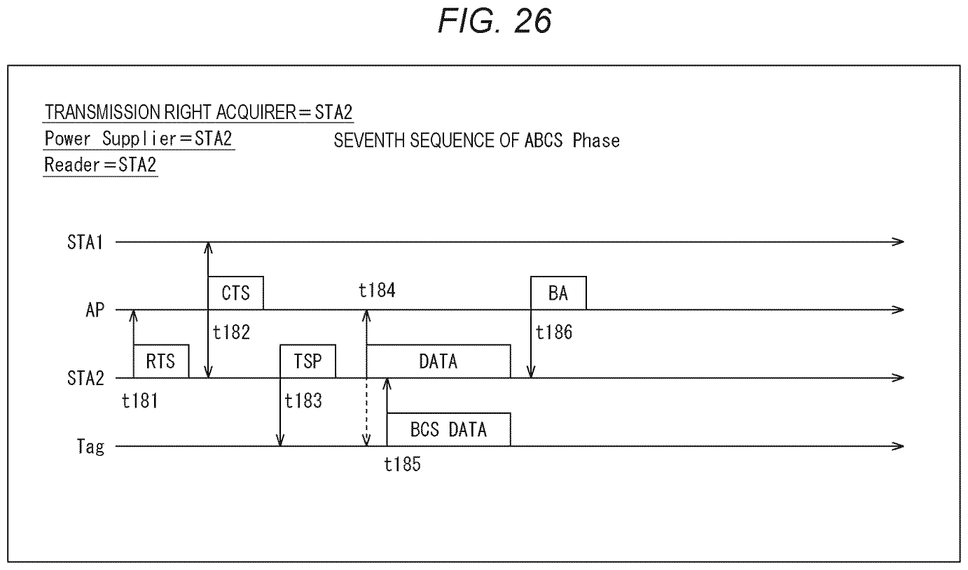

FIG. 26 is a diagram illustrating the seventh sequence of the ABCS Phase.

Hereinafter, the seventh sequence will be described in detail. In the detailed description of the seventh sequence of FIG. 26, FIG. 25 described above is referred to as appropriate.

Since processing at timing t181 and S182 in FIG. 26 is similar to the processing at timing t141 and 142 in FIG. 12, description thereof will be omitted.

At timing t183, the STA2 transmits the TSP to the Tag.

The Tag that has received the TSP checks that its own identification information is included in the TSP.

At timing t184, the STA2 starts transmitting the data signal to the AP (the solid arrow in FIG. 25).

The Tag receives the data signal transmitted from the STA2 to the AP (the dashed arrow in FIG. 25), and transmits the BCS DATA, which is the backscatter signal to which data information to be transmitted is added, to the STA2 at timing t185 (the dashed-dotted arrow in FIG. 25). The STA2 receives the BCS DATA.

Meanwhile, the AP, which has received the data signal transmitted from the STA2, transmits the BA, which is a reception confirmation response signal, to the STA2 at timing t186. The STA2 receives the BA transmitted from the AP. Thereafter, the seventh sequence of FIG. 26 ends.

The seventh sequence of FIG. 26 is different from the fifth sequence of FIG. 22 in that after transmitting the RTS and the CTS, the STA2 transmits the TSP to the Tag, and receives the BCS DATA while transmitting the data signal to the AP.

Note that, in the seventh sequence, since the STA2 needs to simultaneously transmit the data signal and receive the BCS DATA transmitted from the Tag, the STA2 needs to support the In-band FD.

Furthermore, in the seventh sequence, the STA2 may transmit a carrier wave having no information instead of the data signal for the AP. Note that, in this case, the STA2 needs to consider a situation in which the STA2 is restricted to refrain from unnecessary transmission on the basis of its own remaining battery level or the like.

### <Eighth Sequence of ABCS Phase>

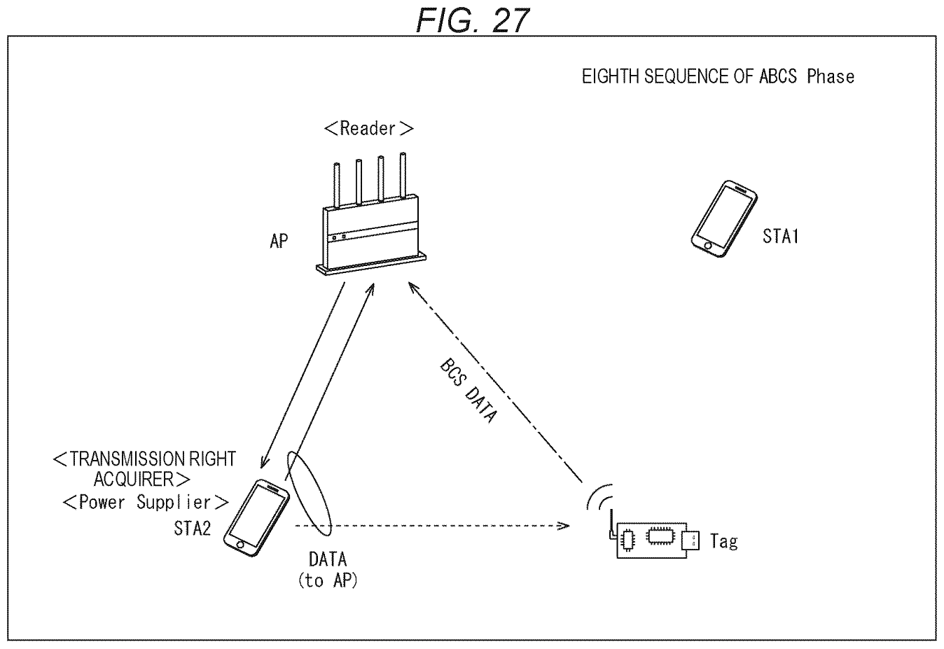

FIG. 27 is a diagram illustrating a signal flow among the communication devices when an eighth sequence of the ABCS Phase is performed.

FIG. 27 illustrates the signal flow among the communication devices when the eighth sequence is performed in a case where the communication devices in charge of the transmission right acquirer, the Power Supplier, and the Reader are the STA2, the STA2, and the AP, respectively.

The STA2, which is the communication device in charge of the Power Supplier, transmits the TSP to the Tag and starts transmitting the data signal to the AP as indicated by the solid arrow.

As indicated by the dashed arrow, the Tag receives the data signal transmitted from the STA2 to the AP. The Tag generates the BCS DATA, which is the backscatter signal to which data information to be transmitted is added, on the basis of the received data signal, and transmits the generated BCS DATA to the AP as indicated by the dashed-dotted arrow.

The AP, which is the communication device in charge of the Reader, receives the BCS DATA and transmits the received BCS DATA to the STA2.

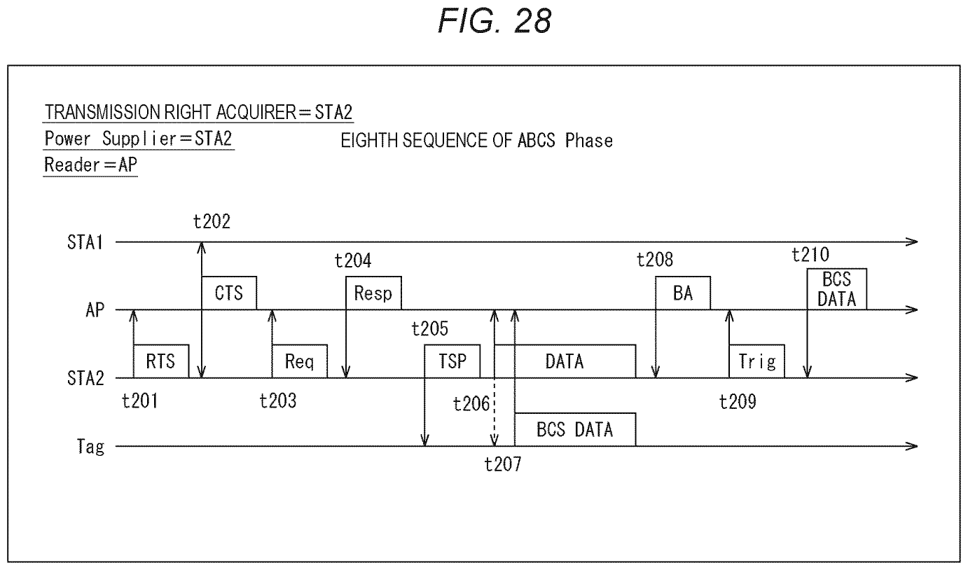

FIG. 28 is a diagram illustrating the eighth sequence of the ABCS Phase.

Hereinafter, the eighth sequence will be described in detail. In the detailed description of the eighth sequence of FIG. 28, FIG. 27 described above is referred to as appropriate.

Since processing at the timing t201 to S204 in FIG. 28 is similar to the processing at the timing t141 to 144 in FIG. 12, description thereof will be omitted.

After receiving the ABCS Response frame as a response signal from the AP, the STA2 transmits the TSP to the Tag at timing t205.

The Tag that has received the TSP checks that its own identification information is included in the TSP.

At timing t206, the STA2 starts transmitting the data signal to the AP (the solid arrow in FIG. 27).

The Tag receives the data signal transmitted from the STA2 to the AP (the dashed arrow in FIG. 27), and transmits the BCS DATA, which is the backscatter signal to which data information to be transmitted is added, to the AP at timing t207 (the dashed-dotted arrow in FIG. 27). The AP receives the BCS DATA.

Meanwhile, the AP, which has received the data signal transmitted from the STA2, transmits the BA, which is a reception confirmation response signal, to the STA2 at timing t208.

The STA2 receives the BA transmitted from the AP, and transmits the Trigger signal for inducing transmission of the BCS DATA to the AP at timing t209.

The AP receives the Trigger signal transmitted from the STA2 and transmits the BCS DATA to the STA2 at timing t210. The STA2 receives the BCS DATA transmitted from the AP. Thereafter, the eighth sequence of FIG. 28 ends.

The eighth sequence in FIG. 28 is different from the fifth sequence in FIG. 22 in that the STA2 transmits the TSP to the Tag after exchange of the ABCS Request frame and the ABCS Response frame between the AP and the STA2 is completed, and then the STA2 starts to transmit the data signal and the AP receives the BCS DATA from the Tag.

Note that, in the eighth sequence, since the AP needs to simultaneously receive the data signal and receive the BCS DATA transmitted from the Tag, the AP needs to support the NOMA.

Furthermore, in the eighth sequence, the STA2 may transmit a carrier wave having no information instead of the data signal for the AP. Note that, in this case, since the AP observes the signal transmitted from the STA2 as an interference wave, at least either the AP has a multi-antenna function such as NOMA or beamforming/beam steering or satisfies sufficient reception quality of the BCS DATA. Furthermore, in this case, the STA2 needs to consider a situation in which the STA2 is restricted to refrain from unnecessary transmission on the basis of its own remaining battery level or the like.

### <Requirement in Each Sequence>

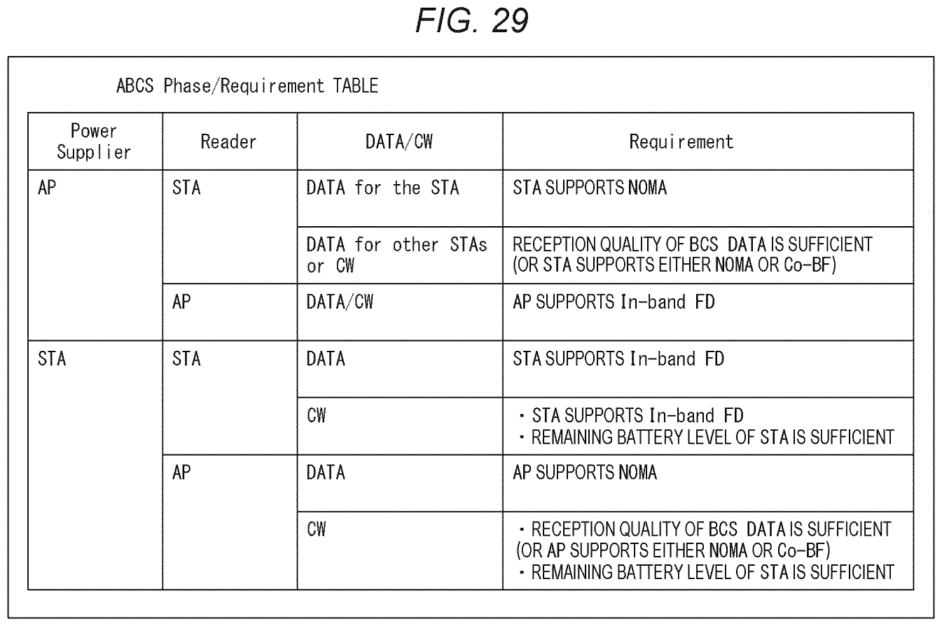

FIG. 29 is a diagram illustrating a requirement table in each sequence of the ABCS Phase.

In FIG. 29, Power Supplier, Reader, signal type (DATA or Continuous Wave (CW, carrier wave)), and requirements are illustrated in order from the left. The signal type is the type of the signal transmitted from the Power Supplier.

In a case where the Power Supplier is the AP, the Reader is the STA, and the signal type is DATA for the STA, it is the requirement that the STA support the NOMA.

In a case where the Power Supplier is the AP, the Reader is the STA, and the signal type is DATA or CW for other STAs, it is the requirement that the reception quality of the BCS DATA be sufficient, or that the STA support either the NOMA or the multi-antenna function. The reception quality being sufficient means that the reception quality is equal to or greater than a predetermined threshold, for example.

Note that the sequences in the case where the Power Supplier is the AP and the Reader is the STA are the first sequence in FIG. 14 and the fifth sequence in FIG. 22 described above.

In a case where the Power Supplier is the AP, the Reader is the AP, and the signal type is DATA or CW, it is the requirement that the AP support the In-band FD.

Note that the sequences in the case where the Power Supplier is the AP and the Reader is the AP are the second sequence in FIG. 16 and the sixth sequence in FIG. 24.

In a case where the Power Supplier is the STA, the Reader is the STA, and the signal type is DATA, it is the requirement that the STA support the In-band FD.

In a case where the Power Supplier is the STA, the Reader is the STA, and the signal type is CW, it is the requirement that the STA support the In-band FD, and the remaining battery level of the STA be sufficient. The remaining battery level being sufficient means that the remaining battery level is equal to or more than a predetermined threshold, for example.

Note that the sequences in the case where the Power Supplier is the STA and the Reader is the STA are the third sequence in FIG. 18 and the seventh sequence in FIG. 26.

In a case where the Power Supplier is the STA, the Reader is the AP, and the signal type is DATA, it is the requirement that the STA support the NOMA.

In a case where the Power Supplier is the STA, the Reader is the AP, and the signal type is CW, it is the requirement that the reception quality of the BCS DATA be sufficient, or that the STA support either the NOMA or the multi-antenna function, and the remaining battery level of the STA be sufficient.

Note that the sequences in the case where the Power Supplier is the STA and the Reader is the AP are the fourth sequence in FIG. 20 and the eighth sequence in FIG. 28.

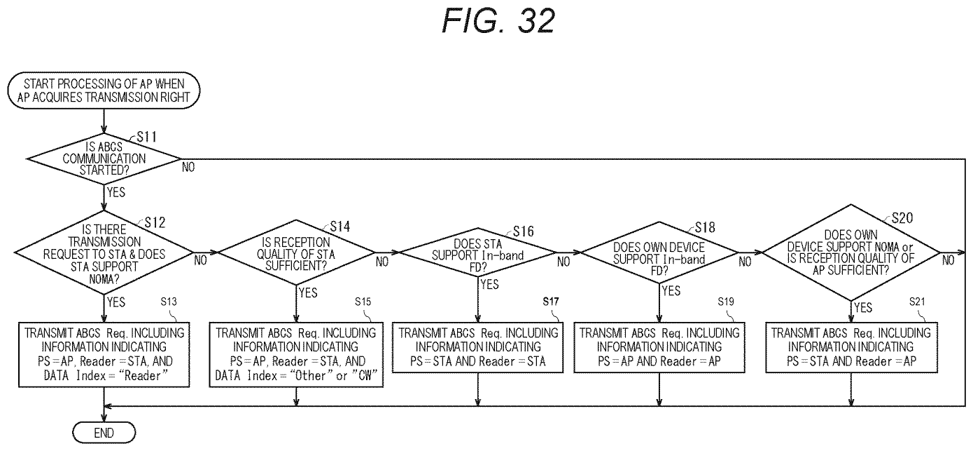

The AP or the STA that becomes the communication device in charge of the transmission right acquirer determines the communication devices that are in charge of the Power Supplier and the Reader on the basis of the requirements given in FIG. 29. Detailed processing of the AP or the STA that becomes the communication device in charge of the transmission right acquirer will be described below with reference to FIGS. 32 to 35.

### <Configuration of ABCS Request Frame>

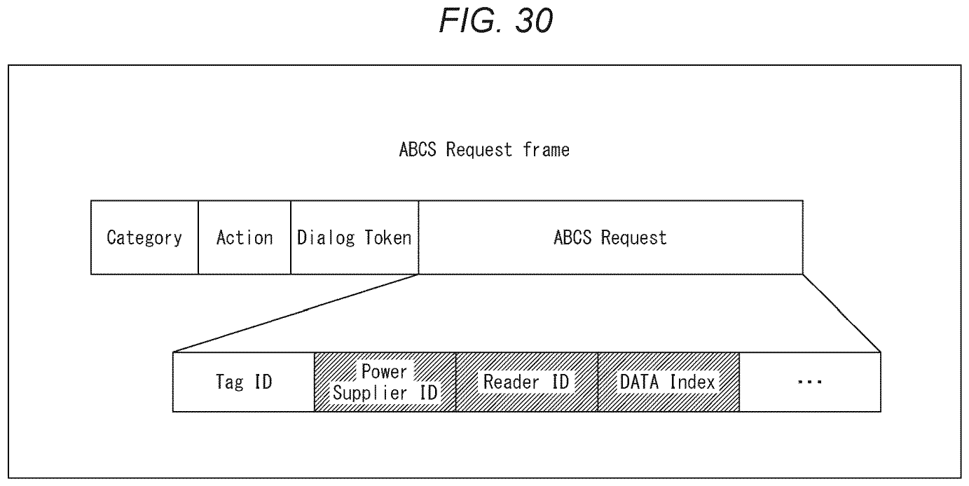

FIG. 30 is a diagram illustrating a configuration example of the ABCS Request frame.

In FIG. 30, the ABCS Request frame is different from the ABCS Operating Mode Notification frame in FIG. 7 in that the ABCS Operating Mode Notification field is replaced with an ABCS Request field.

In FIG. 30, the ABCS Request frame includes fields of Category, Action, Dialog Token, and ABCS Request.

The field of Category includes information indicating that the present Action frame is an ABCS-related frame.

The Action is used in combination with the Category. The field of Action includes information indicating that the present Action frame is the ABCS Request frame.

The field of Dialog Token includes information indicating a processing number of the present Action frame.

The field of ABCS Request includes fields of Tag ID, Power Supplier ID, Reader ID, and DATA Index.

The field of Tag ID includes identification information of a transmission-side Tag of the BCS DATA. The identification information may be a MAC address or identification information that can be managed by the AP.

The field of Power Supplier ID includes identification information of the communication device that operates the Power Supplier.

The field of Reader ID includes identification information of the communication device that operates the Reader.

The field of DATA Index includes information indicating the type of the signal transmitted by the Power Supplier. For example, in a case where the DATA Index is 0, None is indicated. In a case where the DATA Index is 1, the data signal to be transmitted to the Reader is indicated. In a case where the DATA Index is 2, the data signal to be transmitted to the AP is indicated. In a case where the DATA Index is 3, the data signal to be transmitted to Other (a terminal other than the Reader) is indicated. In a case where the DATA Index is 4, the CW (a carrier wave having no data) is indicated.

### <Configuration of ABCS Response Frame>

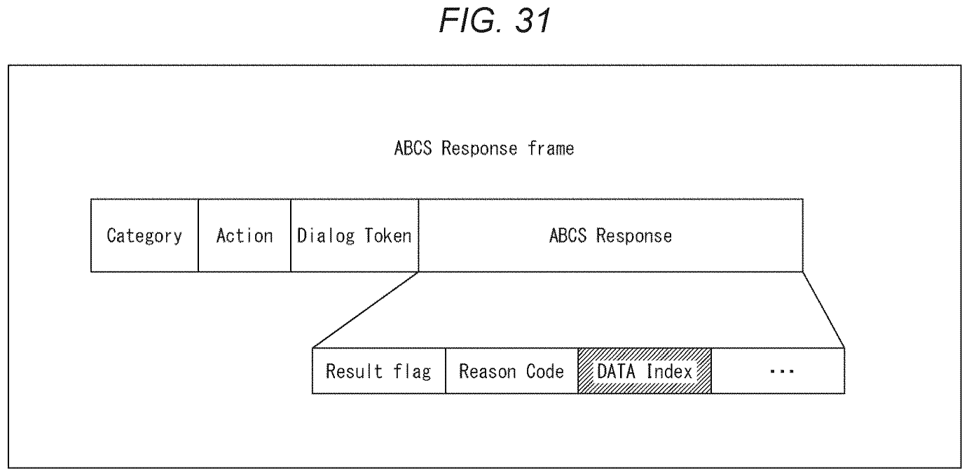

FIG. 31 is a diagram illustrating a configuration example of the ABCS Response frame.

In FIG. 31, the ABCS Response frame is different from the ABCS Operating Mode Notification frame in FIG. 7 in that the ABCS Operating Mode Notification field is replaced with an ABCS Response field.

In FIG. 31, the ABCS Response frame includes fields of Category, Action, Dialog Token, and ABCS Response.

The field of Category includes information indicating that the present Action frame is an ABCS-related frame.

The Action is used in combination with the Category. The field of Action includes information indicating that the present Action frame is the ABCS Response frame.

The field of Dialog Token includes information indicating a processing number of the present Action frame.

The field of ABCS Request includes fields of Result flag, Reason Code, and DATA Index.

The field of Result flag includes flag information indicating whether or not the operation in the role (Power Supplier or Reader) requested in the ABCS Request frame is possible.

The field of Reason Code includes information indicating a reason for false in a case where the Result flag is false. Note that the information indicating a reason for false and a list of the reasons are defined in the standard.

The field of DATA Index includes information indicating the type of the signal transmitted by the Power Supplier, similarly to the case of FIG. 30.

<Processing of AP when AP Acquires Transmission Right>

FIG. 32 is a flowchart for describing processing of the AP when the AP acquires the transmission right.

Note that FIG. 32 illustrates an example of determining each role by prioritizing the following (1) to (3) in this order. (1) The STA becomes the Reader, (2) the transmission right acquirer becomes the Power Supplier, and (3) the Power Supplier transmits data. Note that the flowchart of FIG. 32 is an example, and the Power Supplier and the Reader may be determined in any priority order.

Furthermore, the processing of FIG. 32 is executed by each unit of the wireless communication unit 21 that is controlled by the communication control unit 35 of the communication device 11 of FIG. 2 that operates as the AP.

In step S11, the communication control unit 35 of the AP determines whether or not to start the ABCS communication. In a case where it is determined not to perform the ABCS communication in step S11, the processing of FIG. 32 ends. Thereafter, conventional transmission of the data signal is started.

The communication control unit 35 may determine to start the ABCS communication in a case where a certain period of time has elapsed from the timing when the BCS DATA was last received from the Tag on the basis of the ABCS Interval of the ABCS Operating Mode Notification frame received from the STA, for example. Note that, at that time, the AP may receive timing information at which the STA last acquired the BCS DATA by exchanging information in advance.

In step S11, in a case where it is determined to perform the ABCS communication, the processing proceeds to step S12.

In step S12, the communication control unit 35 determines whether or not the STA that requests the BCS DATA from the Tag is requested to transmit the data signal and whether or not the STA supports the NOMA on the basis of the Capability information exchanged in the Association Phase.

In step S12, in a case where there is a data signal transmission request and it is determined that the STA supports the NOMA, the processing proceeds to step S13.

In step S13, the communication control unit 35 transmits the ABCS Request frame (ABCS Req. in the drawing) including information indicating Power Supplier (PS in the drawing)=AP, Reader=STA, and DATA Index=“Reader” to the STA. Thereafter, the processing in FIG. 32 ends.

In step S12, in a case where there is no data signal transmission request or it is determined that the STA does not support the NOMA, the processing proceeds to step S14.

In step S14, the communication control unit 35 determines whether or not the reception quality of the STA is sufficient in a case where its own device becomes the Power Supplier and the STA becomes the Reader. The reception quality may be determined on the basis of the numerical value measured in the Training Phase, or may be determined on the basis of the Capability information exchanged in the Association Phase.

In step S14, in a case where it is determined that the reception quality of the STA is sufficient, the processing proceeds to step S15.

In step S15, the communication control unit 35 transmits the ABCS Request frame including information indicating Power Supplier=AP, Reader=STA, and DATA Index=“Other” or “CW” to the STA. In this case, the communication control unit 35 transmits the data signal to a device other than the STA or transmits a carrier wave having no data information at the time of transmitting a subsequent signal. Thereafter, the processing in FIG. 32 ends.

In step S14, in a case where it is determined that the reception quality of the STA is not sufficient, the processing proceeds to step S16.

In step S16, the communication control unit 35 determines whether or not the STA supports the In-band FD on the basis of the exchanged Capability information as a result of mutual transmission in the Association Phase.

In step S16, in a case where it is determined that the STA supports the In-band FD, the processing proceeds to step S17.

In step S17, the communication control unit 35 transmits the ABCS Request frame including information indicating Power Supplier=STA and Reader=STA to the STA. Thereafter, the processing in FIG. 32 ends.

In step S16, in a case where it is determined that the STA does not support the In-band FD, the processing proceeds to step S18.

In step S18, the communication control unit 35 determines whether or not its own device supports the In-band FD.

In step S18, in a case where it is determined that its own device supports the In-band FD, the processing proceeds to step S19.

In step S19, the communication control unit 35 transmits the ABCS Request frame including information indicating Power Supplier=AP and Reader=AP to the STA. Thereafter, the processing in FIG. 32 ends.

In step S18, in a case where it is determined that its own device does not support the In-band FD, the processing proceeds to step S20.

In step S20, the communication control unit 35 determines whether or not its own device supports the NOMA, or whether or not its own reception quality is sufficient in a case where the STA is the Power Supplier and its own device is the Reader. This reception quality may also be determined on the basis of the numerical value measured in the Training Phase, or may be determined on the basis of the Capability information exchanged in the Association Phase.

In step S20, in a case where it is determined that its own device supports the NOMA or its own reception quality is sufficient, the processing proceeds to step S21.

In step S21, the communication control unit 35 transmits the ABCS Request frame including information indicating Power Supplier=STA and Reader=AP to the STA. Thereafter, the processing in FIG. 32 ends.

In step S20, in a case where it is determined that its own device does not support the NOMA and its own reception quality is not sufficient, it is determined that the ABCS communication is impossible, and the processing of FIG. 32 ends. In this case, for example, conventional transmission of the data signal is started.

<Processing of STA when AP Acquires Transmission Right>

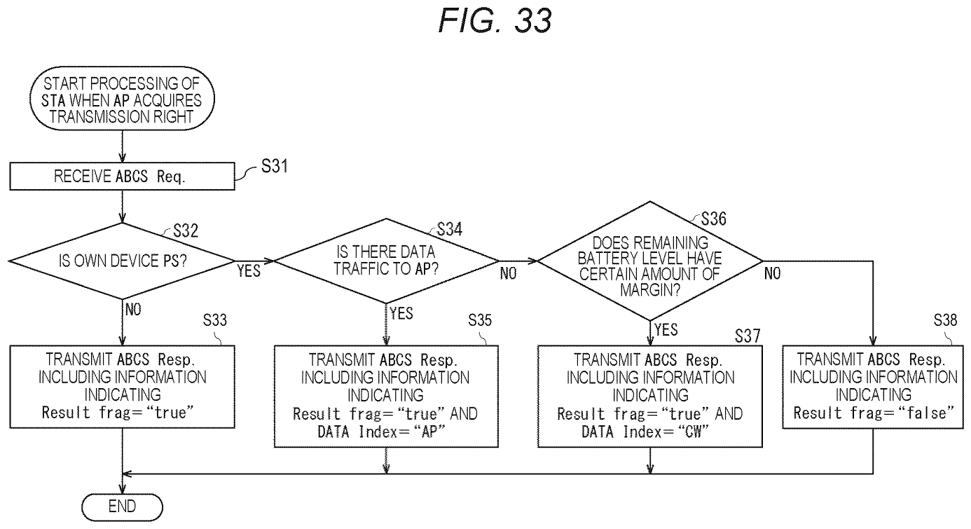

FIG. 33 is a flowchart for describing processing of the STA when the AP acquires transmission right.

Furthermore, the processing of FIG. 33 is executed by each unit of the wireless communication unit 61 that is controlled by the communication control unit 75 of the communication device 51 of FIG. 3 that operates as the STA.

In step S31, the communication control unit 75 of the STA receives the ABCS Request frame.

In step S32, the communication control unit 75 refers to the received ABCS Request frame and determines whether or not its own device is the Power Supplier. In a case where its own device is not the Power Supplier but is the Reader, it is determined that its own device is not the Power Supplier in step S32, and the processing proceeds to step S33.

In step S33, the communication control unit 75 transmits the ABCS Response frame (ABCS Resp. in the drawing) including information indicating Result frag=“true” to the AP.

In a case where it is determined in step S32 that its own device is not the Power Supplier, the processing proceeds to step S34.

In step S34, the communication control unit 75 determines whether or not there is data traffic to the AP. The data traffic to the AP indicates data to be transmitted to the AP. In a case where a certain amount of data traffic to the AP is held, it is determined in step S34 that there is data traffic to the AP, and the processing proceeds to step S35.

In step S35, the communication control unit 75 transmits the ABCS Response frame including information indicating Result frag=“true” and DATA Index=“AP” to the AP. Thereafter, the processing in FIG. 33 ends.

In step S34, in a case where it is determined that there is no data traffic to the AP, the processing proceeds to step S36.

In step S36, the communication control unit 75 checks its own remaining battery level and determines whether or not the remaining battery level has a certain amount of margin. In a case where it is determined in step S36 that the remaining battery level has a certain amount of margin, the processing proceeds to step S37.

In step S37, the communication control unit 75 transmits the ABCS Response frame including information indicating Result frag=“true” and DATA Index=“CW” to the AP. In this case, the communication control unit 75 transmits a carrier wave having no information at the time of transmitting a subsequent signal. Thereafter, the processing in FIG. 33 ends.

In step S36, in a case where it is determined that the remaining battery level does not have a certain amount of margin, the processing proceeds to step S38.

In step S38, the communication control unit 75 transmits the ABCS Response frame including information indicating Result frag=“false” to the AP. Thereafter, the processing in FIG. 33 ends.

Note that the STA may terminate the process by, for example, transmitting the ABCS Response frame including information indicating Result frag=“false” to the AP for a reason other than the termination in FIG. 33. For example, in a case where new BCS DATA from the Tag is not needed, the STA may not start the ABCS communication.

<Processing of STA when STA Acquires Transmission Right>

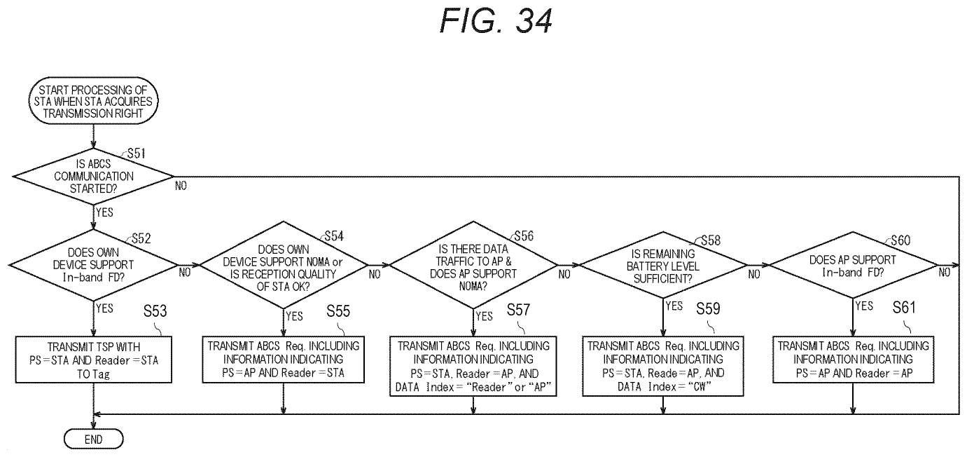

FIG. 34 is a flowchart for describing processing of the STA when the STA acquires transmission right.

Note that the processing of FIG. 34 is executed by each unit of the wireless communication unit 61 that is controlled by the communication control unit 75 of the communication device 51 of FIG. 3 that operates as the STA.

In step S51, the communication control unit 75 of the STA determines whether or not to start the ABCS communication. In a case where it is determined not to perform the ABCS communication in step S51, the processing of FIG. 34 ends.

Thereafter, conventional transmission of the data signal is started.

For example, in a case where a certain period of time has elapsed from the timing when the BCS DATA was last received from the Tag, the communication control unit 75 may determine to start the ABCS communication.

In step S51, in a case where it is determined to perform the ABCS communication, the processing proceeds to step S52.

In step S52, the communication control unit 75 determines whether or not its own device supports the In-band FD. In a case where it is determined in step S52 that its own device supports the In-band FD, the processing proceeds to step S53.

In step S53, the communication control unit 75 transmits the TSP to the Tag with Power Supplier=STA and Reader=STA. Thereafter, the processing in FIG. 34 ends.

In a case where it is determined in step S52 that its own device does not support the In-band FD, the processing proceeds to step S54.

In step S54, the communication control unit 75 determines whether or not its own device supports the NOMA, or whether or not the reception quality on the STA side is sufficient in a case where the AP is the Power Supplier and its own device is the Reader. The reception quality may be determined on the basis of the numerical value measured in the Training Phase, or may be determined on the basis of the Capability information exchanged in the Association Phase.

In step S54, in a case where it is determined that its own device supports the NOMA, or the reception quality of the STA is sufficient in a case where the AP is the PS and its own device is the Reader, the processing proceeds to step S55.

In step S55, the communication control unit 75 transmits the ABCS Request frame including information indicating Power Supplier=AP and Reader=STA to the AP. Thereafter, the processing in FIG. 34 ends.

In step S54, in a case where it is determined that its own device does not support the NOMA, and the reception quality of the STA is not sufficient in a case where the AP is the PS and its own device is the Reader, the processing proceeds to step S56.

In step S56, the communication control unit 75 determines whether or not its own device has the data traffic to the AP, and whether or not the AP supports the NOMA on the basis of the Capability information exchanged in the Association Phase.

In step S56, in a case where its own device has the data traffic to the AP, and the AP supports the NOMA, the processing proceeds to step S57.

In step S57, the communication control unit 75 transmits the ABCS Request frame including information indicating Power Supplier=STA, Reader=AP, and DATA Index=“Reader” or “AP” to the AP. Thereafter, the processing in FIG. 34 ends.

In step S56, in a case where its own device has no data traffic to the AP, or the AP does not support the NOMA, the processing proceeds to step S58.

In step S58, the communication control unit 75 determines whether or not its own remaining battery level is sufficient. In a case where it is determined in step S58 that its own remaining battery level is sufficient, the processing proceeds to step S59.

In step S59, the communication control unit 75 transmits the ABCS Request frame including information indicating Power Supplier=STA, Reader=AP, and DATA Index=“CW” to the AP. Thereafter, the processing in FIG. 34 ends.

In step S58, in a case where it is determined that its own remaining battery level is not sufficient, the processing proceeds to step S60.

In step S60, the communication control unit 75 determines whether or not the AP supports the In-band FD on the basis of the exchanged Capability information as a result of mutual transmission in the Association Phase.

In step S60, in a case where it is determined that the AP supports the In-band FD, the processing proceeds to step S61.

In step S61, the communication control unit 75 transmits the ABCS Request frame including information indicating Power Supplier=AP and Reader=AP to the STA.

In step S60, in a case where it is determined that the AP does not support the In-band FD, it is determined that the ABCS communication is impossible, and the processing of FIG. 34 ends.

In this case, for example, conventional transmission of the data signal is started.

<Processing of AP when STA Acquires Transmission Right>

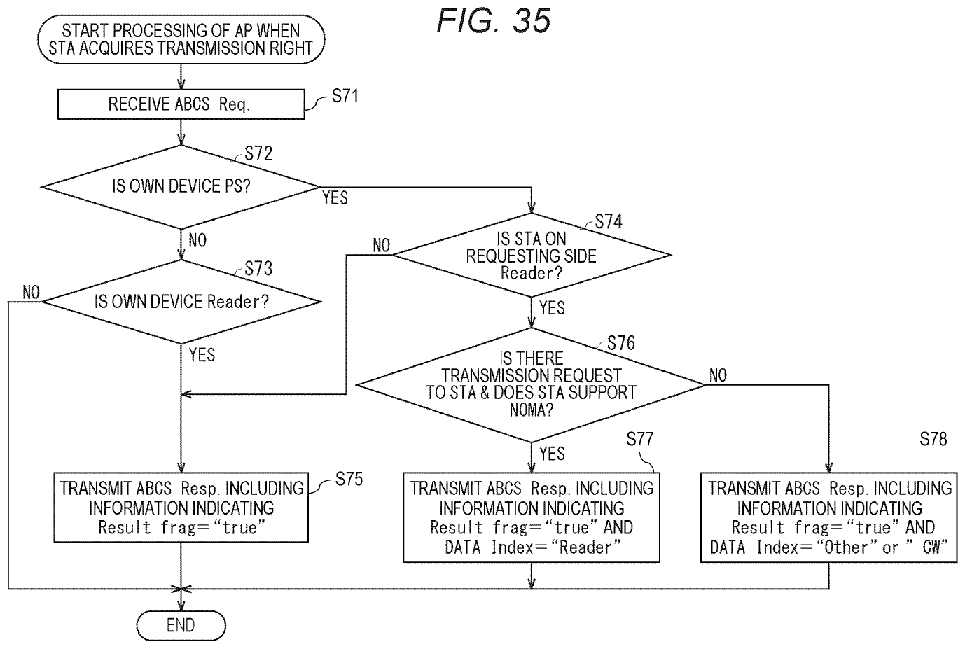

FIG. 35 is a flowchart for describing processing of the AP when the STA acquires transmission right.

Furthermore, the processing of FIG. 35 is executed by each unit of the wireless communication unit 21 that is controlled by the communication control unit 35 of the communication device 11 of FIG. 2 that operates as the AP.

In step S71, the communication control unit 35 of the AP receives the ABCS Request frame.

In step S72, the communication control unit 35 refers to the received ABCS Request frame and determines whether or not its own device is the Power Supplier. In a case where it is determined in step S72 that its own device is not the Power Supplier, the processing proceeds to step S73.

In step S73, the communication control unit 35 determines whether or not its own device is the Reader. In a case where it is determined in step S73 that its own device is not the Reader, the processing of FIG. 35 ends.

In a case where it is determined in step S73 that its own device is the Reader, the processing proceeds to step S75.

Furthermore, in step S72, in a case where it is determined that its own device is the Power Supplier, the processing proceeds to step S74.

In step S74, the communication control unit 35 determines whether or not the STA on the requesting side of the ABCS Request frame is the Reader. In a case where it is determined in step S75 that the STA on the requesting side is not the Reader, the processing proceeds to step S75.

In step S75, the communication control unit 35 transmits the ABCS Response frame including information indicating Result frag=“true” to the STA. Thereafter, the processing in FIG. 35 ends.

On the other hand, in step S74, in a case where it is determined that the STA on the requesting side is the Reader, the processing proceeds to step S76.

In step S76, the communication control unit 35 determines whether or not there is a data signal transmission request to the requesting STA, and whether or not the STA supports the NOMA on the basis of the Capability information exchanged as a result of mutual transmission in the Association Phase.

In step S76, in a case where there is a data signal transmission request to the requesting STA, and it is determined that the STA supports the NOMA, the processing proceeds to step S77.

In step S77, the communication control unit 35 transmits the ABCS Response frame including information indicating Result frag=“true” and DATA Index=“Reader” to the STA.

In step S76, in a case where there is no data signal transmission request to the requesting STA or it is determined that the STA does not support the NOMA, the processing proceeds to step S78.

In step S78, the communication control unit 35 transmits the ABCS Response frame including information indicating Result frag=“true” and DATA Index=“Other” or “CW” to the STA.

Note that the AP may terminate the process by, for example, transmitting the ABCS Response frame including information indicating Result frag=“false” to the STA for a reason other than the termination in FIG. 35. Furthermore, for example, in a case where new BCS DATA from the Tag is not needed, the AP may not start the ABCS communication.

### 2. Modifications

### <Another Configuration of Communication Device>

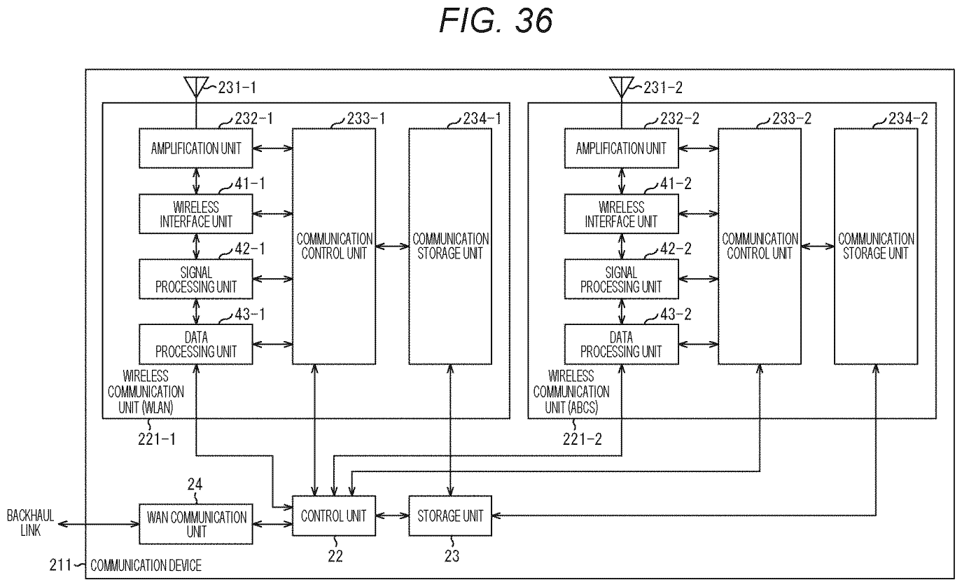

FIG. 36 is a block diagram illustrating another configuration example of a communication device that operates as an AP.

A communication device 211 of FIG. 36 is different from the communication device 11 of FIG. 2 in that the wireless communication unit 21 is replaced with a WLAN wireless communication unit 221-1 and an ABCS wireless communication unit 221-2.

The communication device 211 includes the wireless communication unit 221-1 for WLAN, the wireless communication unit 221-2 for ABCS, a control unit 22, a storage unit 23, and a WAN communication unit 24.

The wireless communication unit 221-1 for WLAN includes an antenna 231-1, an amplification unit 232-1, a wireless interface unit 41-1, a signal processing unit 42-1, a data processing unit 43-1, a communication control unit 233-1, and a communication storage unit 234-1.

The wireless communication unit 221-2 for ABCS includes an antenna 231-2, an amplification unit 232-2, a wireless interface unit 41-1, a signal processing unit 42-1, a data processing unit 43-1, a communication control unit 233-2, and a communication storage unit 234-2.

The antennas 231-1 and 231-2 are configured similarly to the antenna 31 in FIG. 2.

The amplification units 232-1 and 232-2 are configured similarly to the amplification unit 32 in FIG. 2.

The communication control units 233-1 and 233-2 are configured similarly to the communication control unit 35 in FIG. 2.

The communication storage units 234-1 and 234-2 are configured similarly to the communication storage unit 36 in FIG. 2.

In the present technology, a communication device operating as an AP can have the configuration illustrated in FIG. 36. However, the communication device 211 having the configuration of FIG. 36 does not have an interference canceller function, and thus cannot perform functions such as In-band FD and NOMA.

### <Another Configuration of Communication Device>

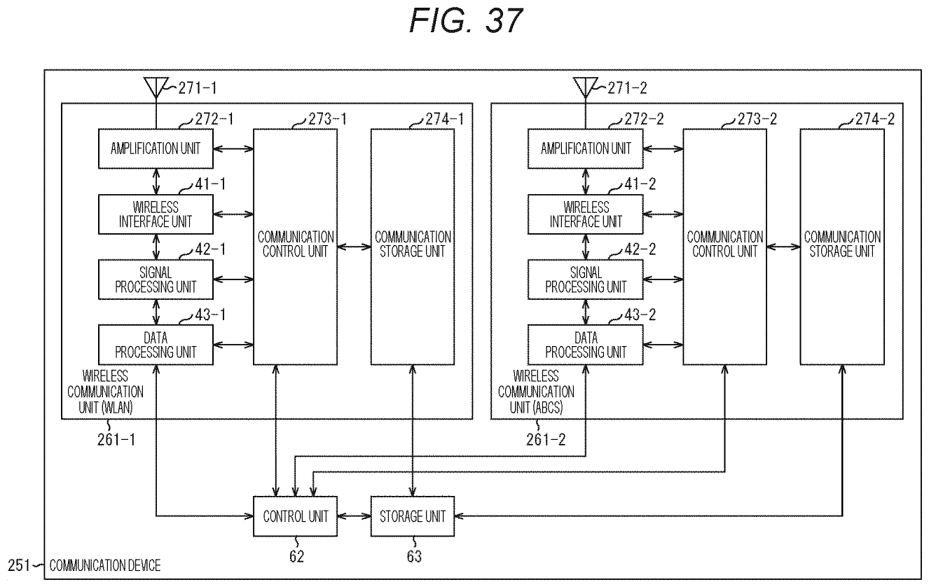

FIG. 37 is a block diagram illustrating another configuration example of a communication device that operates as an STA.

A communication device 251 of FIG. 37 is different from the communication device 51 of FIG. 3 in that the wireless communication unit 61 is replaced with a WLAN wireless communication unit 261-1 and an ABCS wireless communication unit 261-2.

The communication device 251 includes the wireless communication unit 261-1 for WLAN, the wireless communication unit 261-2 for ABCS, a control unit 22, a storage unit 23, and a WAN communication unit 24.

The wireless communication unit 261-1 for WLAN includes an antenna 271-1, an amplification unit 272-1, a wireless interface unit 41-1, a signal processing unit 42-1, a data processing unit 43-1, a communication control unit 273-1, and a communication storage unit 274-1.

The wireless communication unit 261-2 for ABCS includes an antenna 271-2, an amplification unit 272-2, a wireless interface unit 41-1, a signal processing unit 42-1, a data processing unit 43-1, a communication control unit 273-2, and a communication storage unit 274-2.

The antennas 271-1 and 271-2 are configured similarly to the antenna 31 in FIG. 2.

The amplification units 272-1 and 272-2 are configured similarly to the amplification unit 32 in FIG. 2.

The communication control units 273-1 and 273-2 are configured similarly to the communication control unit 35 in FIG. 2.

The communication storage units 274-1 and 274-2 are configured similarly to the communication storage unit 36 in FIG. 2.

In the present technology, a communication device operating as an STA can have the configuration illustrated in FIG. 37. However, the communication device 251 having the configuration of FIG. 37 does not have an interference canceller function, and thus cannot perform functions such as In-band FD and NOMA.

### 3. Application

### <System Configuration of First Application>

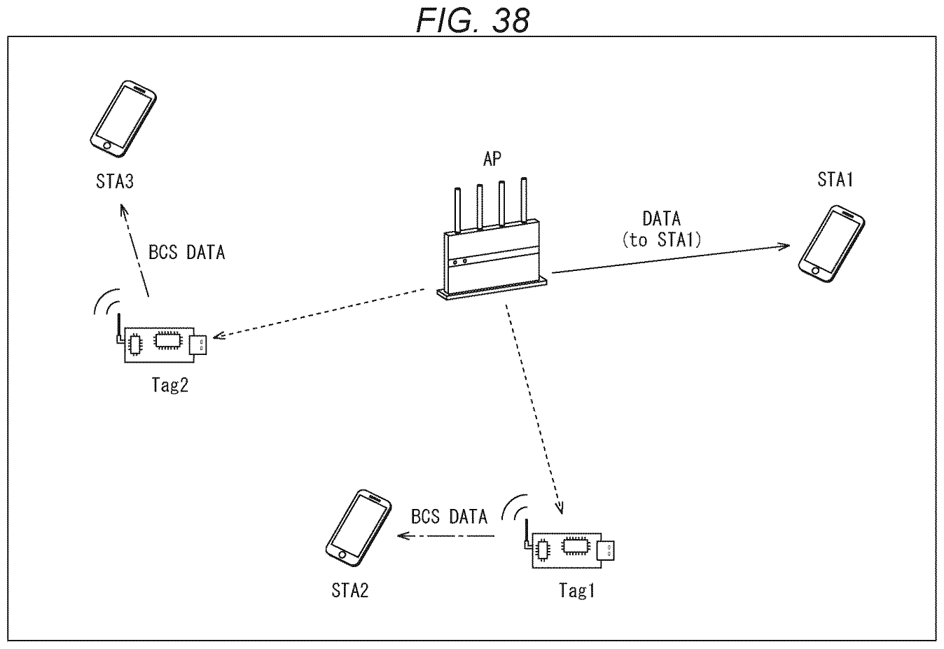

FIG. 38 is a diagram illustrating another configuration example of a wireless communication system according to an embodiment of the present technology.

FIG. 1 of the above-described embodiment illustrates the wireless communication system in which only one Tag exists, but FIG. 38 illustrates a wireless communication system in which a plurality of Tags exists in the same network.

The wireless communication system in FIG. 38 includes one AP, STA1 to STA3 that are three STAs, and Tag1 and Tag2 that are two sensor tags. Note that the STA1 to the STA3 will be referred to as STA(s) in a case where it is not particularly necessary to distinguish them. The Tag1 and the Tag2 will be referred to as Tag(s) in a case where it is not particularly necessary to distinguish them.

The AP transmits a signal (DATA) to the STA1.

The STA1 to STA3 are connected to the AP. The STA1 receives a signal transmitted from the AP. The STA2 directly receives (acquires) the BCS DATA transmitted from the Tag1. The STA3 directly receives (acquires) the BCS DATA transmitted from the Tag2.

Note that there is a case where the AP once receives the BCS DATA transmitted from the Tag1 and then transmits the BCS DATA to the STA2, whereby the STA2 indirectly receives the BCS DATA, depending on the Capability and the communication quality status. Similarly, there is a case where the AP once receives the BCS DATA transmitted from the Tag2 and then transmits the BCS DATA to the STA3, whereby the STA3 indirectly receives the BCS DATA, depending on the Capability and the communication quality status.

The Tag1 transmits the BCS DATA to the STA2, using a method of modulating, reflecting and/or absorbing a wireless signal transmitted from a surrounding AP or STA. The Tag2 transmits the BCS DATA to the STA3, using a method of modulating, reflecting and/or absorbing a wireless signal transmitted from a surrounding AP or STA.

Note that, in the case of FIG. 38, even if a plurality of the Tags transmits the BCS DATA at the same time, if the Tags do not mutually interfere with the other Readers, the AP may become the Power Supplier and perform operation to cause the plurality of Tags to transmit the BCS DATA at the same time. Specifically, by performing the following extension from the above-described embodiment, it becomes possible for the AP to be the Power Supplier and cause the plurality of Tags to transmit the BCS DATA at the same time.
The AP notifies the number of Tags enabled in the same network using a notification signal such as a Beacon. Being enabled means that the AP is notified by each STA in the ABCS Operating Mode Notification frame.
The TSP is transmitted a plurality of times or is extended to be able to specify a plurality of Tags.
The TSP is transmitted a plurality of times or is extended to be able to specify a plurality of Tags.
In Training Phase, the reception quality measurement for the simultaneous transmission from the plurality of Tags is performed.
A plurality of Tag IDs in various frames and information groups added thereto are extended so as to be included in the same frame.
In the ABCS Phase, the priority order in which each terminal determines the Power Supplier and Reader is changed on the basis of the number of enabled Tags. For example, in the above-described present embodiment, it is prioritized that the STA becomes the Reader, but in a case where there is a plurality of Tags in the same network, the role determination may be performed by prioritizing that the AP becomes the Power Supplier. Note that whether or not a plurality of Tags exists in the same network can be determined on the basis of information notified by a Beacon or the like.
In a case where the AP becomes the Reader in the ABCS Phase, the AP may notify, as the Capability information, information indicating the maximum number of Tags from which the BCS DATA can be simultaneously received.

### <Second Application>

The user may set the transmission of the ABCS Operating Notification frame in the above-described present embodiment, or the user may set ON and OFF of a power saving mode related to the remaining battery level.

The setting by the user may be input on a UI on the STA side. Furthermore, the presence or absence of communication from the Tag and the applied role may be displayed on the UI of the STA.

### 5. Others

### <Effects of Present Technology>

In the present technology, the AP or the STA (communication control device) receives the ABCS Request frame (role request signal) requesting execution of the role related to the transmission of the BCS DATA (backscatter signal) by the Tag (backscatter signal generation device), and determines the operation on the basis of the role request signal.

Therefore, according to the present technology, it is possible to optimally determine and operate the role related to communication of the backscatter signal. As a result, it is possible to optimally perform communication of the backscatter signal. Furthermore, according to the present technology, the following effects can be obtained as compared with a case where the Power Supplier and the Reader are fixed and operated in a predetermined communication device as in the related art.

As far as the Power Supplier and Reader are possible, the STA is determined to directly receive information from the Tag, so that a communication delay can be reduced.

Meanwhile, even in a case where it is difficult to receive information from the Tag due to interference, it is possible to reliably transmit information from the Tag to the STA via the AP or the like.

When each of the AP and the STA determines and executes the optimal role at the time of acquiring the transmission right, it is possible to improve a probability that information from the Tag can be received (acquired) at necessary timing.

By giving a degree of freedom to the type (data signal or carrier wave) of the signal transmitted by the Power Supplier and the destination (Reader or other terminals), it is possible to expect an effect of preventing stagnation of traffic. For example, according to the Capability information of the AP, the STA can supply a signal to the Tag to cause the AP to receive the information from the Tag, and at the same time, can transmit the data signal to the AP.

Note that, in the above description, the example in which the backscatter signal is generated by the sensor tag has been described, but the device is not limited to the sensor tag as long as the device can generate the backscatter signal.

### <Configuration Example of Computer>

The series of processing steps described above can be executed by hardware and also can be executed by software. In a case where the series of processing steps is executed by software, a program included in the software is installed from a program recording medium on a computer incorporated in dedicated hardware, a general-purpose personal computer, or the like.

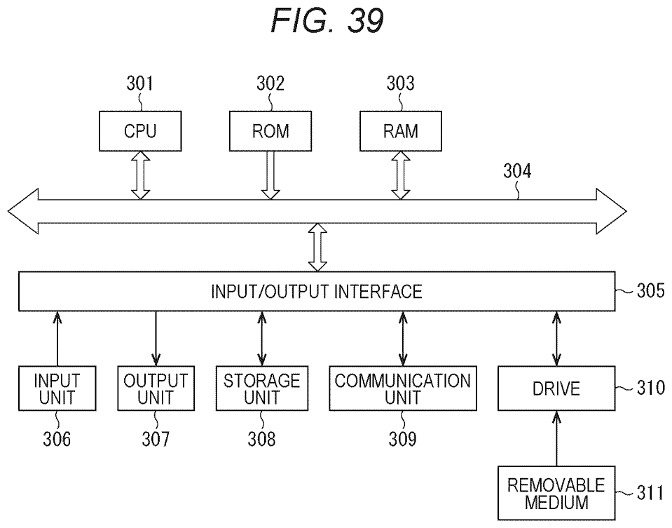

FIG. 39 is a block diagram illustrating a configuration example of the hardware of the computer that executes the above-described series of processes by the program.

A central processing unit (CPU) 301, a read only memory (ROM) 302, and a random access memory (RAN) 303 are connected to each other by a bus 304.

Moreover, to the bus 304, an input/output interface 305 is connected. To the input/output interface 305, an input unit 306 including a keyboard, a mouse, and the like, and an output unit 307 including a display, a speaker, and the like are connected. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, for example, the CPU 301 loads a program stored in the storage unit 308 into the RAM 303 via the input/output interface 305 and the bus 304 and executes the program to perform the above-described series of processing.

The program to be executed by the CPU 301 is provided, for example, by being recorded on the removable medium 311 or via a wired or wireless transmission medium such as a local area network, the Internet, or digital broadcasting, and is installed on the storage unit 308.

Note that the program executed by the computer may be a program in which processing is performed in time series in the order described in the present specification or may be a program in which processing is performed in parallel or at necessary timing such as when a call is made.

### Application Examples

The present technology can be applied to various products. For example, the communication device 11 in FIG. 2 and the communication device 51 in FIG. 3 may be implemented as a mobile terminal such as a smartphone, a tablet personal computer (PC), a notebook PC, a portable game terminal, or a digital camera, a fixed terminal such as a television receiver, a printer, a digital scanner, or a network storage, or an in-vehicle terminal such as a car navigation device. Furthermore, the communication device 11 and the communication device 51 may be implemented as a machine to machine communication (M2M) terminal such as a smart meter, a vending machine, a remote monitoring device, or a point of sale (POS) terminal. Moreover, the communication device 11 and the communication device 51 may each be a wireless communication module (for example, an integrated circuit module including one die) mounted on these terminals.

On the other hand, for example, the communication device 11 and the communication device 51 may be implemented as a wireless LAN AP (wireless base station) having a router function or not having a router function. Furthermore, the communication device 11 and the communication device 51 may be implemented as mobile wireless LAN routers. Moreover, the communication device 11 and the communication device 51 may be wireless communication modules (for example, an integrated circuit module including one die) mounted on these devices.

### <Configuration Example of Smartphone>

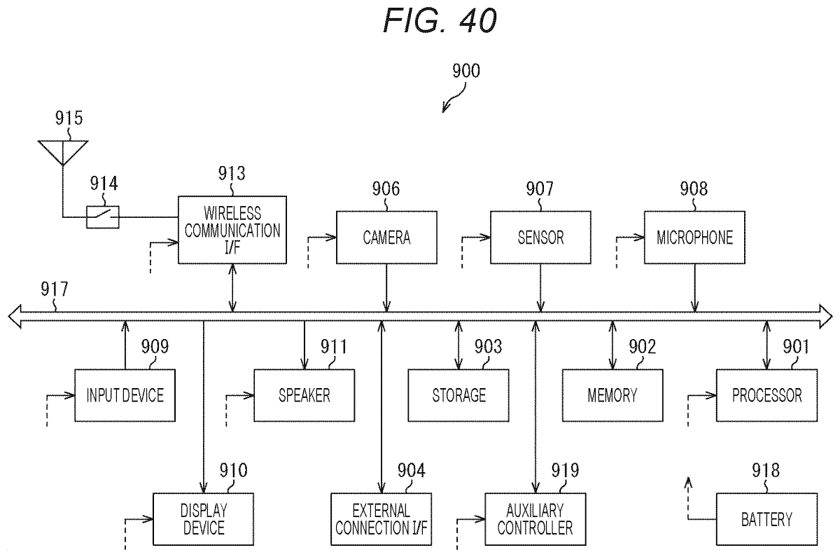

FIG. 40 is a block diagram illustrating a schematic configuration example of the smartphone to which the present technology is applied.

A smartphone 900 includes a processor 901, a memory 902, a storage 903, an external connection interface 904, a camera 906, a sensor 907, a microphone 908, an input device 909, and a display device 910. Furthermore, the smartphone 900 includes a speaker 911, a wireless communication interface 913, an antenna switch 914, an antenna 915, a bus 917, a battery 918, and an auxiliary controller 919.

The processor 901 may be, for example, a CPU or a system on chip (SoC), and restricts functions of an application layer and other layers of the smartphone 900.

The memory 902 includes a RAM and a ROM, and stores a program to be executed by the processor 901, and data.

The storage 903 may include a storage medium such as a semiconductor memory or a hard disk.

The external connection interface 904 is an interface for connecting an external device such as a memory card or a universal serial bus (USB) device to the smartphone 900.

The camera 906 includes an imaging element such as a charge coupled device (CCD) or a complementary metal oxide semiconductor (CMOS), for example, and generates a captured image.

The sensor 907 includes, for example, a sensor group including a positioning sensor, a gyro sensor, a geomagnetic sensor, and an acceleration sensor.

The microphone 908 converts audio input to the smartphone 900 into an audio signal.

The input device 909 includes, for example, a touch sensor that detects a touch on a screen of the display device 910, a keypad, a keyboard, a button, and a switch, and receives an operation by the user or information input from the user.

The display device 910 has a screen such as a liquid crystal display (LCD) or an organic light emitting diode (OLED) display, and converts the audio signal output from the smartphone 900 into audio.

The wireless communication interface 913 supports one or more of wireless LAN standards such as IEEE 802.11a, 11b, 11g, 11ac, and 11ad, and performs wireless communication.

The wireless communication interface 913 communicates with other devices via the wireless LAN AP in an infrastructure mode. Furthermore, the wireless communication interface 913 directly communicates with other devices in an ad hoc mode or a direct communication mode such as Wi-Fi Direct.

Note that, in Wi-Fi Direct, unlike the ad hoc mode, one of two terminals operates as an AP, but communication is directly performed between the terminals.

The wireless communication interface 913 typically includes a baseband processor, a radio frequency (RF) circuit, and a power amplifier. The wireless communication interface 913 may be a one-chip module in which a memory that stores a communication control program, a processor that executes the program, and related circuits are integrated.

In addition to the wireless LAN scheme, the wireless communication interface 913 may support other types of wireless communication schemes such as a short-range wireless communication scheme, a proximity wireless communication scheme, and a cellular communication scheme.

The antenna switch 914 switches a connection destination of the antenna 915 among a plurality of circuits (for example, circuits for different wireless communication schemes) included in the wireless communication interface 913.

The antenna 915 has a single or a plurality of antenna elements (for example, a plurality of the antenna elements forming a multiple input multiple output (MIMO) antenna), and is used for transmission and reception of a wireless signal by the wireless communication interface 913.

Note that the smartphone 900 is not limited to the example in FIG. 40, and may include a plurality of the antennas (for example, an antenna for the wireless LAN, an antenna of the proximity wireless communication scheme, and the like). In that case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to one another.

The battery 918 supplies power to each block of the smartphone 900 illustrated in FIG. 40 through a feed line partially indicated by the dashed line in the drawing. The auxiliary controller 919 causes operation of minimum necessary functions of the smartphone 900, for example, in a sleep mode.

In the smartphone 900 illustrated in FIG. 40, for example, the communication control unit 35 in FIG. 2 or the communication control unit 75 in FIG. 3 may be implemented in the wireless communication interface 913. Furthermore, at least some of these functions may be implemented in the processor 901 or the auxiliary controller 919.

Note that the smartphone 900 may operate as a wireless AP (software AP) when the processor 901 executes an AP function at an application level. Furthermore, the wireless communication interface 913 may have the wireless AP function.

Moreover, the smartphone 900 may include a biometric authentication unit (fingerprint authentication, palm-shape authentication, voice authentication, blood vessel authentication, face authentication, iris authentication, and retina authentication). At that time, the wireless communication interface 913 in which the communication control unit 35 in FIG. 2 or the communication control unit 75 in FIG. 3 is implemented is configured to receive power supply from the same battery 918 as at least one of the display device 910, the speaker 911, or the biometric authentication unit.

Furthermore, in the smartphone 900, information is displayed from at least one of the display device 910 or the speaker 911 on the basis of communication with an external device through the wireless communication interface 913. At that time, the information regarding the present technology may be output from at least one of the display device 910 or the speaker 911.

### <Configuration Example of In-Vehicle Device>

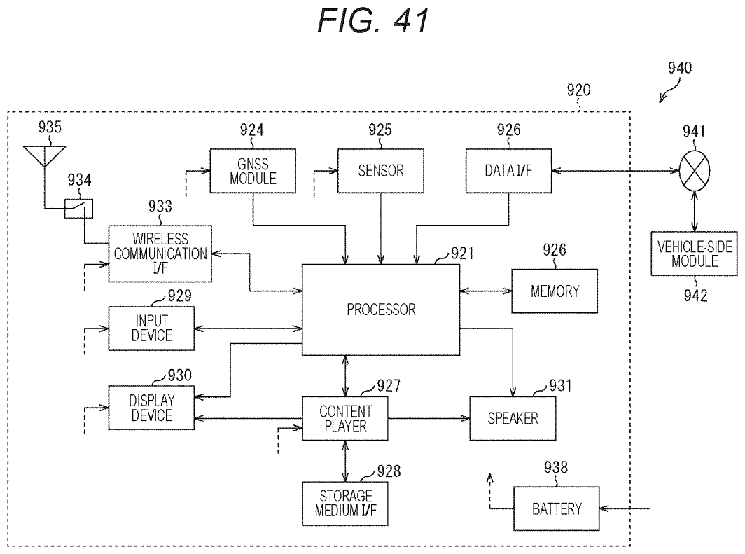

FIG. 41 is a block diagram illustrating a schematic configuration example of an in-vehicle device 920 to which the present technology is applied.

The in-vehicle device 920 includes a processor 921, a memory 922, a global navigation satellite system (GNSS) module 924, a sensor 925, a data interface 926, a content player 927, and a storage medium interface 928. Furthermore, the in-vehicle device 920 includes an input device 929, a display device 930, a speaker 931, a wireless communication interface 933, an antenna switch 934, an antenna 935, and a battery 938.

The processor 921 may be, for example, a CPU or an SoC, and controls a navigation function and other functions of the in-vehicle device 920. Furthermore, the processor 921 can also control a drive system of a vehicle, such as a brake, an accelerator, or a steering, on the basis of information obtained through communication based on the present technology.

The memory 922 includes a RAM and a ROM, and stores a program to be executed by the processor 921, and data.

The GNSS module 924 uses a GNSS signal received from a GNSS satellite to measure a location (for example, latitude, longitude, and altitude) of the in-vehicle device 920.

The sensor 925 includes, for example, a sensor group including a gyro sensor, a geomagnetic sensor, and an air pressure sensor.

The data interface 926 is connected to an in-vehicle network 941 via, for example, a terminal (not illustrated), and acquires data generated on the vehicle side, such as in-vehicle data.

The content player 927 reproduces contents stored in a storage medium (for example, a CD or a DVD) inserted into the storage medium interface 928.

The input device 929 includes, for example, a touch sensor that detects a touch on a screen of the display device 930, a button, a switch, or the like, and receives an operation by the user or information input from the user.

The display device 930 has a screen such as an LCD or an OLED display, and displays an image of a navigation function or contents to be reproduced.

The speaker 931 outputs sound of the navigation function or contents to be reproduced.

Note that, in the in-vehicle device 920, the navigation function and the function of the content player 927 are optional. The navigation function and the content player 927 may be removed from the configuration of the in-vehicle device 920.

The wireless communication interface 933 supports one or more of wireless LAN standards such as IEEE 802.11a, 11b, 11g, 11n, 11ac, 11ad, 11ax, and 11be, and performs wireless communication. The wireless communication interface 933 communicates with other devices via the wireless LAN AP in the infrastructure mode. Furthermore, the wireless communication interface 933 directly communicates with other devices in an ad hoc mode or a direct communication mode such as Wi-Fi Direct.

The wireless communication interface 933 typically includes a baseband processor, an RF circuit, and a power amplifier. The wireless communication interface 933 may be a one-chip module in which a memory that stores a communication control program, a processor that executes the program, or related circuits are integrated. In addition to the wireless LAN scheme, the wireless communication interface 933 may support other types of wireless communication schemes such as a short-range wireless communication scheme, a proximity wireless communication scheme, and a cellular communication scheme.

The antenna switch 934 switches a connection destination of the antenna 935 among a plurality of circuits included in the wireless communication interface 933.

The antenna 935 has a single or a plurality of antenna elements, and is used for transmission and reception of a wireless signal through the wireless communication interface 933.

Note that the in-vehicle device 920 is not limited to the example in FIG. 41, and may include a plurality of the antennas 935. In that case, the antenna switch 934 may be omitted from the configuration of the in-vehicle device 920.

In the in-vehicle device 920 illustrated in FIG. 41, the battery 938 may supply power through a feed line partially illustrated by the dashed line in the drawing, and for example, the communication control unit 35 in FIG. 2 or the communication control unit 75 in FIG. 3 may be mounted in the wireless communication interface 933. Furthermore, at least some of these functions may be implemented in the processor 921.

Furthermore, the wireless communication interface 933 may operate as the above-described communication device 11 or communication device 51, and provide wireless connection to a terminal possessed by a user in the vehicle.

Furthermore, the present technology may be implemented as an in-vehicle system (or vehicle) 940 including one or more blocks of the in-vehicle device 920 described above, the in-vehicle network 941, and a vehicle-side module 942. The vehicle-side module 942 generates vehicle-side data such as a vehicle speed, an engine speed, or failure information, and outputs the generated data to the in-vehicle network 941.

### <Configuration Example of Wireless AP>

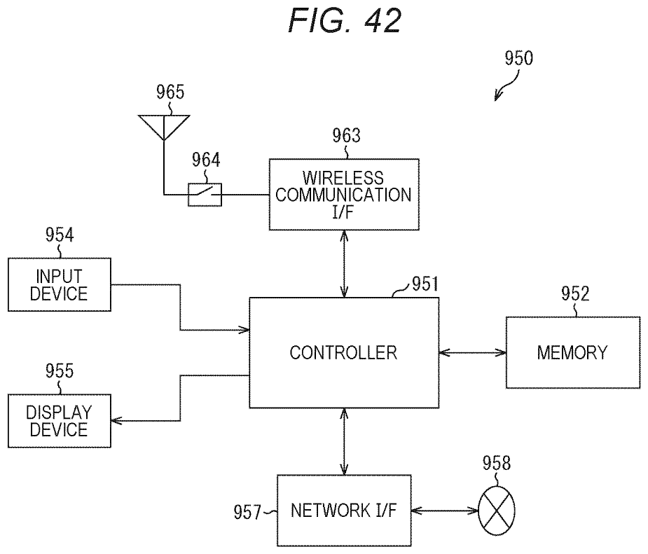

FIG. 42 is a block diagram illustrating a schematic configuration example of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

The controller 951 may be, for example, a CPU or a digital signal processor (DSP), and operates various functions (for example, access restriction, routing, encryption, firewall, log management, and the like) of the Internet protocol (IP) layer and higher layer of the wireless AP 950.

The memory 952 includes a RAM and a ROM, and stores a program to be executed by the controller 951 and various control information (for example, a terminal list, a routing table, an encryption key, a security setting, a log, and the like).

The input device 954 includes, for example, a button and a switch, and receives an operation from the user.

The display device 955 includes an LED lamp and the like, and displays an operation status of the wireless AP 950.

The network interface 957 is a wired communication interface for connecting the wireless AP 950 to a wired communication network 958. The network interface 957 may have a plurality of connection terminals. The wired communication network 958 may be a LAN such as Ethernet (registered trademark), or may be a wide area network (WAN).

The wireless communication interface 963 supports one or more of the wireless LAN standards such as IEEE 802.11a, 11b, 11g, 11n, 11ac, and 11ad, and provides wireless connection as an AP to a nearby terminal.

The wireless communication interface 963 typically includes a baseband processor, an RF circuit, and a power amplifier.

The wireless communication interface 963 may be a one-chip module in which a memory that stores a communication control program, a processor that executes the program, or related circuits are integrated.

The antenna switch 964 switches a connection destination of the antenna 965 among a plurality of circuits included in the wireless communication interface 963, and the antenna 965 has a single or a plurality of antenna elements and is used for transmission and reception of a wireless signal through the wireless communication interface 963.

In the wireless AP 950 illustrated in FIG. 42, for example, the communication control unit 35 in FIG. 2 or the communication control unit 75 in FIG. 3 may be implemented in the wireless communication interface 963. Furthermore, at least some of these functions may be implemented in the controller 951.

Note that, the above-described embodiments describe an example for embodying the present technology, and there is a correspondence relationship between the matters in the embodiments and the matters specifying the invention in claims. Similarly, there is a correspondence relationship between the matters specifying the invention in claims and the matters in the embodiments of the present technology having the same names. However, the present technology is not limited to the embodiments, and can be embodied by applying various modifications to the embodiments without departing from the scope of the present technology.

Furthermore, the procedures described in the above-described embodiment may be considered as a method including a series of procedures and may be considered as a program for causing this computer to execute the series of procedures and a recording medium that stores the program.

As this recording medium, for example, a compact disc (CD), a MiniDisc (MD), a digital versatile disc (DVD), a memory card, a Blu-ray (registered trademark) Disc, and the like can be used.

Note that, in the present specification, a system means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both systems.

Furthermore, the effects described in the present specification are merely examples and not restrictive, and there may also be other effects.

An embodiment of the present technology is not limited to the embodiment described above, and various modifications can be made without departing from the scope of the present technology.

For example, the present technology may be configured as cloud computing in which one function is shared by a plurality of devices via a network and processed in cooperation.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### Combination Examples of Configurations

The present technology can also be configured as follows.

(1)

A communication control device including:
a communication control unit configured to receive a role request signal requesting execution of a role related to communication of a backscatter signal by a backscatter signal generation device, and determine an operation on the basis of the role request signal.

(2)

The communication control device according to (1) above, in which
the role is at least one of a first role of transmitting a first wireless signal necessary for the backscatter signal generation device to generate the backscatter signal or a second role of receiving the backscatter signal transmitted by the backscatter signal generation device.

(3)

The communication control device according to (2) above, in which
the backscatter signal generation device generates the backscatter signal by performing at least one of reflection or absorption of the first wireless signal.

(4)

The communication control device according to (2) or (3) above, in which
the role request signal includes first identification information indicating a communication device that plays the first role and second identification information indicating a communication device that plays the second role, and
the communication control unit determines an operation on the basis of the first identification information and the second identification information.

(5)

The communication control device according to (4) above, in which
the communication device that plays the first role and the communication device plays the second role are determined on the basis of capability information indicating a function of each of the communication devices.

(6)

The communication control device according to (5) above, in which
the capability information includes information indicating presence or absence of an interference canceller function.

(7)

The communication control device according to (6) above, in which
the information indicating presence or absence of an interference canceller function includes information indicating whether or not supporting Non-orthogonal Multiple Access (NOMA) or information indicating whether or not supporting In-band Full Duplex.

(8)

The communication control device according to (4) above, in which
the communication device that plays the first role and the communication device that plays the second role are determined on the basis of reception quality information indicating reception quality of the backscatter signal of each of the communication devices.

(9)

The communication control device according to (8) above, in which
the reception quality information includes a reception signal to interference and noise ratio (SINR) or a bit error rate of the backscatter signal.

(10)

The communication control device according to (8) above, in which
the communication device that plays the second role is determined for a communication device in which the reception quality information is equal to or larger than a predetermined threshold.

(11)

The communication control device according to any one of (4) to (9) above, in which
the communication devices that play the first role and the second role are determined for communication devices supporting In-band Full Duplex.

(12)

The communication control device according to any one of (4) to (9) above, in which
the communication device that plays the second role is determined for a communication device supporting NOMA.

(13)

The communication control device according to any one of (4) to (9) above, in which
the communication device that plays the first role is determined for a communication device having data to be transmitted or a communication device having a remaining battery level higher than a threshold.

(14)

The communication control device according to any one of (4) to (9) above, in which,
in a case where the communication control unit is provided in a communication device that plays the first role, the communication control unit determines whether or not to permit an operation as the first role on the basis of a data status to be transmitted by the communication control unit and a remaining battery level.

(15)

The communication control device according to any one of (2) to (14) above, in which,
in a case of receiving a measurement request signal of reception quality of the backscatter signal, the communication control unit measures the reception quality on the basis of a backscatter signal for measurement and transmits reception quality information indicating the measured reception quality.

(16)

The communication control device according to any one of (2) to (14) above, in which,
in a case of receiving a signal transmission request for measurement of reception quality of the backscatter signal, the communication control unit transmits a second signal necessary to generate a backscatter signal for measurement.

(17)

A communication control method in which
a communication control device receives a role request signal requesting execution of a role related to communication of a backscatter signal by a backscatter signal generation device, and determines an operation on the basis of the role request signal.

(18)

A program for causing a computer to function as:
a communication control unit configured to receive a role request signal requesting execution of a role related to communication of a backscatter signal by a backscatter signal generation device, and determine an operation on the basis of the role request signal.

### REFERENCE SIGNS LIST

11 Communication device
21 Wireless communication unit
22 Control unit
23 Storage unit
24 WAN communication unit
31 Antenna
32 Amplification unit
33 WLAN unit
34 ABCS unit
35 Communication control unit
36 Communication storage unit
41, 41-1, 41-2 Wireless interface unit
42, 42-1, 42-2 Signal processing unit
43, 43-1, 43-2 Data processing unit
51 Communication device
61 Wireless communication unit
62 Control unit
63 Storage unit
71 Antenna
72 Amplification unit
73 WLAN unit
74 ABCS unit
75 Communication control unit
76 Communication storage unit
111 Communication device
121 Wireless communication unit
122 Control unit
123 Storage unit
131 Antenna
132 Switching unit
133 Signal reflection/absorption control unit
134 Transmission signal processing unit
135 Reception signal detection unit
136 Reception signal processing unit
137 Communication control unit

What is claimed is:

1. A communication control device comprising:
a communication control unit configured to receive a role request signal requesting execution of a role related to communication of a backscatter signal by a backscatter signal generation device, and determine an operation on a basis of the role request signal.

2. The communication control device according to claim 1, wherein
the role is at least one of a first role of transmitting a first wireless signal necessary for the backscatter signal generation device to generate the backscatter signal or a second role of receiving the backscatter signal transmitted by the backscatter signal generation device.

3. The communication control device according to claim 2, wherein
the backscatter signal generation device generates the backscatter signal by performing at least one of reflection or absorption of the first wireless signal.

4. The communication control device according to claim 2, wherein
the role request signal includes first identification information indicating a communication device that plays the first role and second identification information indicating a communication device that plays the second role, and
the communication control unit determines an operation on a basis of the first identification information and the second identification information.

5. The communication control device according to claim 4, wherein
the communication device that plays the first role and the communication device that plays the second role are determined on a basis of capability information indicating a function of each of the communication devices.

6. The communication control device according to claim 5, wherein
the capability information includes information indicating presence or absence of an interference canceller function.

7. The communication control device according to claim 6, wherein
the information indicating presence or absence of an interference canceller function includes information indicating whether or not supporting Non-orthogonal Multiple Access (NOMA) or information indicating whether or not supporting In-band Full Duplex.

8. The communication control device according to claim 4, wherein
the communication device that plays the first role and the communication device that plays the second role are determined on a basis of reception quality information indicating reception quality of the backscatter signal of each of the communication devices.

9. The communication control device according to claim 8, wherein
the reception quality information includes a reception signal to interference and noise ratio (SINR) or a bit error rate of the backscatter signal.

10. The communication control device according to claim 8, wherein
the communication device that plays the second role is determined for a communication device in which the reception quality information is equal to or larger than a predetermined threshold.

11. The communication control device according to claim 4, wherein
the communication devices that play the first role and the second role are determined for communication devices supporting In-band Full Duplex.

12. The communication control device according to claim 4, wherein
the communication device that plays the second role is determined for a communication device supporting NOMA.

13. The communication control device according to claim 4, wherein
the communication device that plays the first role is determined for a communication device having data to be transmitted or a communication device having a remaining battery level higher than a threshold.

14. The communication control device according to claim 4, wherein,
in a case where the communication control unit is provided in a communication device that plays the first role, the communication control unit determines whether or not to permit an operation as the first role on a basis of a data status to be transmitted by the communication control unit and a remaining battery level.

15. The communication control device according to claim 2, wherein,
in a case of receiving a measurement request signal of reception quality of the backscatter signal, the communication control unit measures the reception quality on a basis of a backscatter signal for measurement and transmits reception quality information indicating the measured reception quality.

16. The communication control device according to claim 2, wherein,
in a case of receiving a signal transmission request for measurement of reception quality of the backscatter signal, the communication control unit transmits a second wireless signal necessary to generate a backscatter signal for measurement.

17. A communication control method in which
a communication control device receives a role request signal requesting execution of a role related to communication of a backscatter signal by a backscatter signal generation device, and determines an operation on a basis of the role request signal.

18. A program for causing a computer to function as:
a communication control unit configured to receive a role request signal requesting execution of a role related to communication of a backscatter signal by a backscatter signal generation device, and determine an operation on a basis of the role request signal.
